(19) United States
(12) Patent Application Publication
(10) Pub. No.: US 2019/0329187 A1
(43) Pub. Date: Oct. 31, 2019

(54) AFFINITY POLYMERS AND METHODS FOR REDUCING PURINE LEVELS IN COMPLEX MIXTURES

(71) Applicant: NITTO DENKO CORPORATION, Osaka (JP)

(72) Inventors: Brett T. Harding, Oceanside, CA (US); Robb Bagge, Vista, CA (US); Jesse Dan Froehlich, Vista, CA (US); Lyudmyla Y. Chumakova, San Diego, CA (US); Joanna Czulak, Bedford (GB); Antonio Guerreiro, Bedfordshire (GB)

(21) Appl. No.: 16/399,803

(22) Filed: Apr. 30, 2019

Related U.S. Application Data
(60) Provisional application No. 62/664,815, filed on Apr. 30, 2018.
(60) Provisional application No. 62/664,830, filed on Apr. 30, 2018.

(51) Int. Cl. B01D 71/40; B01D 69/12; C08F 20/36; C12C 7/28; C12F 3/06; C08F 20/38

(52) U.S. Cl. CPC B01D 71/40; B01D 69/125; C08F 20/36; B01D 2239/1216; C12F 3/06; C08F 20/38; C08F 2810/20; C12C 7/28

(57) ABSTRACT

This disclosure relates to an affinity polymer composite comprising a product of reacting a precursor mixture comprising at least one cross-linking monomer component having two or more ethenyl moieties suitable for polymerization; wherein the affinity polymer composite has a first binding energy with a purine compound that is at least 1 kcal/mole more favorable than a second binding energy with a flavor compound in a complex mixture. Some embodiments include a filtration medium comprising the affinity polymer composite described herein, wherein the affinity polymer composite has a primary particle diameter of about 45 micrometers to about 150 micrometers. Some embodiments include a filtration column comprising the filtration medium described herein. Some embodiments include a method for the removal of a purine compound from a complex mixture using the filtration medium described herein.

### CROSS-REFERENCE TO RELATED APPLICATIONS

This application claims the benefit of U.S. Provisional Application No. 62/664,815, filed Apr. 30, 2018, and U.S. Provisional Application No. 62/664,830, filed Apr. 30, 2018, which are incorporated by reference herein in their entireties.

### FIELD

This disclosure relates to the use of affinity polymer composites for removing purines from complex mixtures. In some embodiments, the complex mixtures can be beer or wort solutions.

### BACKGROUND

There is a growing variety of fermented malt beverages, such as beer and malt beer, on the market. In recent years, health-conscious consumers have sought reduced levels of sugar and calorie content in their fermented malt beverages. Furthermore, there has been a growing interest in these drinks' purine amount. One consideration is that these purine compounds can be metabolized in the liver to uric acid: the consumer may show symptoms of hyperuricemia when the uric acid level in the blood rises above a certain value. In some instances, the crystallized uric acid can be accumulated and result in gout or a joint affected therewith. To address these concerns, removing purines using various adsorbents has attracted interest. However, use of these methodologies can also remove constituents that affect the taste of the fermented beverage.

As a result, there is a desire to maintain the taste of a conventional beer while reducing the fermented malt beverage purine content. There is a need for a new method for removing purines from complex mixtures, such as beers and worts, while retaining aesthetic flavors and aromas of those mixtures.

### SUMMARY

A method for reducing purine levels in complex mixtures is described herein. Some embodiments include a method for reducing purine levels in beer or wort liquids. In some embodiments a method for reducing purine levels while maintaining beer flavor compounds is provided.

Some embodiments include an affinity polymer composite comprising a product of reacting a precursor mixture comprising at least one cross-linking monomer component having two or more ethenyl moieties suitable for polymerization; wherein the affinity polymer composite has a first binding energy with a purine compound that is at least 1 kcal/mole more favorable than a second binding energy with a flavor compound in a complex mixture.

Some embodiments include a filtration medium comprising the affinity polymer composite described herein, wherein the affinity polymer composite has a primary particle diameter of about 45 micrometers to about 150 micrometers.

Some embodiments include a filtration column comprising the filtration medium described herein.

Some embodiments include a method for the removal of a purine compound from a complex mixture comprising: treating a complex mixture with the filtration medium described herein, wherein the complex mixture comprises a purine compound and a flavor compound; wherein the filtration medium removes more of the purine compound from the complex mixture as compared to the amount of a flavor compound removed from the complex mixture.

Some embodiments include a heterogeneous mixture comprising a malt beverage and the affinity polymer composite described herein.

An affinity polymer composite is described herein. The affinity polymer composite comprises at least one cross-linking monomer component having two or more ethenyl or polymerizable moieties. The composite may further comprise one or more monomer components comprising a compound bearing one ethenyl group suitable for polymerization. In some embodiments, the monomer component or component having one ethenyl group may be part of an acryloyl group or a vinyl group. In some cases, a monomer or monomers may further comprise an acidic group. In some examples, the acidic group may be a boronic acid, a sulfonic acid, a phosphoric acid, or a carboxylic acid group, or a salt thereof. The cross-linking monomer having two or more ethenyl groups may have a first binding energy with a purine at least 5 kcal/mole different (and more favorable) than a second binding energy with flavor compound.

Some embodiments include a filtration medium, e.g. a filtration medium comprising the affinity polymer composite materials described herein. In some embodiments, the affinity polymer composite material of the filtration medium can have a primary particle diameter of 45-150 micrometers. Some embodiments include a filtration column which comprises the affinity polymer composite materials described herein.

Some embodiments include a method for reducing purine levels in mixed liquid. Such a method can comprise contacting a complex mixed solution or liquid with purine compounds and flavor compounds with affinity polymer composite. In some embodiments, the complex mixture can be a beer or wort. In some embodiments, the purine compound can be adenine, adenosine, guanine, guanosine, hypoxanthine, inosine, xanthosine, xanthine, or a combination thereof. In some embodiments, the flavor compound can be a carbohydrate, maltose, isoamyl acetate, ethyl acetate, an iso-alpha acid (e.g. isohumulone, trans-isohumulone, trans-isocohumulone, and trans-isoadhumulone), another flavor ester, or a combination thereof.

### BRIEF DESCRIPTION OF THE DRAWINGS

FIG. 1 is a graph depicting the selective removal of materials from a methanol solution by an embodiment of an affinity polymer described herein.

FIG. 2 is a graph depicting the selective removal of materials from a simulated beer solution by an embodiment of an affinity polymer described herein.

FIG. 3 is a graph depicting the selective removal of materials from a simulated beer solution by an embodiment of an affinity polymer described herein.

### DETAILED DESCRIPTION

The term “Ion chromatography”, “ion-exchange chromatography” or “ion-exchange” refers to a chromatography process that separates ions and polar molecules based on their affinity to the ion exchanger.

The term “affinity”, “affinity chromatography” or “affinity purification” refers to the use of specific binding interactions, in addition to and/or instead of their overall ionic interaction between molecules. In some embodiments, a particular monomer[s] can be a particular ligand used by itself or that can be chemically immobilized or “coupled” to a solid support so that when a complex mixture is passed over the column, those molecules e.g., a purine, having specific binding affinity and/or binding energy, to the ligand, e.g., a selected monomer, can become bound. After retention of eluate, a complex mixture retaining desired compounds, e.g., flavor compounds, at the expense of other compounds, e.g., purines, is provided. After other sample components are washed away, the bound molecule can be stripped from the support, resulting in its selective purification from the original sample. After other sample components are washed away, the bound molecule can be stripped from the support, resulting in its selective purification from the original sample.

The term “wort” refers to the liquid extracted from the mashing process during the brewing of beer or whisky. Wort contains the sugars, for example maltose, that will be fermented by the brewing yeast to produce alcohol. In beer making, the wort is known as “sweet wort” until the hops have been added, after which it is called “hopped or bitter wort”.

The term “beer” refers to the fermented liquid with added yeast. During fermentation, the wort becomes beer in a process which requires a week to months depending on the type of yeast and strength of the beer. In addition to producing ethanol, fine particulate matter suspended in the wort settles during fermentation. Once fermentation is complete, the yeast also settles, leaving the beer clear.

The term “purine” or “purine analog” refers an optionally substituted compound containing the ring system:

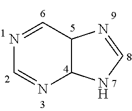

The term “ethenyl” an optionally substituted carbon-carbon double bond [C═C], which may be substituted or unsubstituted. Examples of ethenyl moieties include,

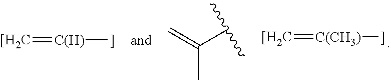

The term “acryloyl” refers to an optionally substituted moiety, where the parent structure is

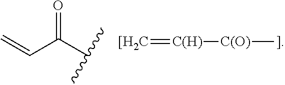

Acryloyl groups are also sometimes termed acryl groups or acrylyl groups. Substituents may be present on either or both of the vinylic carbon atoms. The carbonyl group of an acryloyl moiety is usually bound to an oxygen atom (providing an acrylate group) or to a nitrogen atom (providing an acrylamide group).

The term “methacryloyl” refers to a substituted acryloyl moiety having the formula

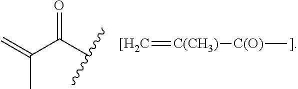

Methacryloyl groups are also sometimes termed methacryl groups or methacrylyl groups. The carbonyl group of a methacryloyl moiety is usually bound to an oxygen atom (providing a methacrylate group) or to a nitrogen atom (providing a methacrylamide group).

Some embodiments include a composite material for the selective removal of purine compounds from beer or wort. In some embodiments, the selective removal can be by affinity purification. In some embodiments, a chromatographic or filtration media, and/or a chromatographic or filtration column for selective removal of purine compounds is described. In some embodiments, affinity polymer composite materials are described that can remove guanosine from a pH 4 aqueous (with 5% volume ethanol) solution with minimal effect on the concentration of flavor compounds, e.g., ethyl acetate, isoamyl acetate, and/or iso-alpha acids. In some embodiments, the polymer composite material is removable from the beer or wort solution. In some embodiments, the polymer materials have a reduced contamination effect upon the beer or wort solution. In some embodiments, the polymer material does not break down and does not remain in the beer or wort after processing.

Some embodiments include a method or material for selective removal of purine compounds. In some embodiments, a purine composition level may be reduced. In some embodiments, the total concentration of purines can be reduced from a range of about 23 ppm to about 120 ppm down to below 10 ppm, 7.5 ppm, 5 ppm, 1 ppm, 500 ppb, 250 ppb, 100 ppb, and/or 50 ppb. Some embodiments include a method for removing or reducing purine levels in a liquid. In some embodiments, the purine composition removed or reduced can comprise a compound of the following Formula 1:

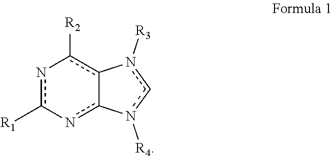

In some embodiments, at least one of R₁ and R₂ can be a hydrogen, an amine group (—NH₂), and/or a hydroxyl group (—OH), and/or a carbonyl group (═O); wherein R³ and or R₄ can be a lone electron pair, hydrogen, a ribose sugar or a phosphate ribose sugar. In some embodiments, the removed purine compound can include:

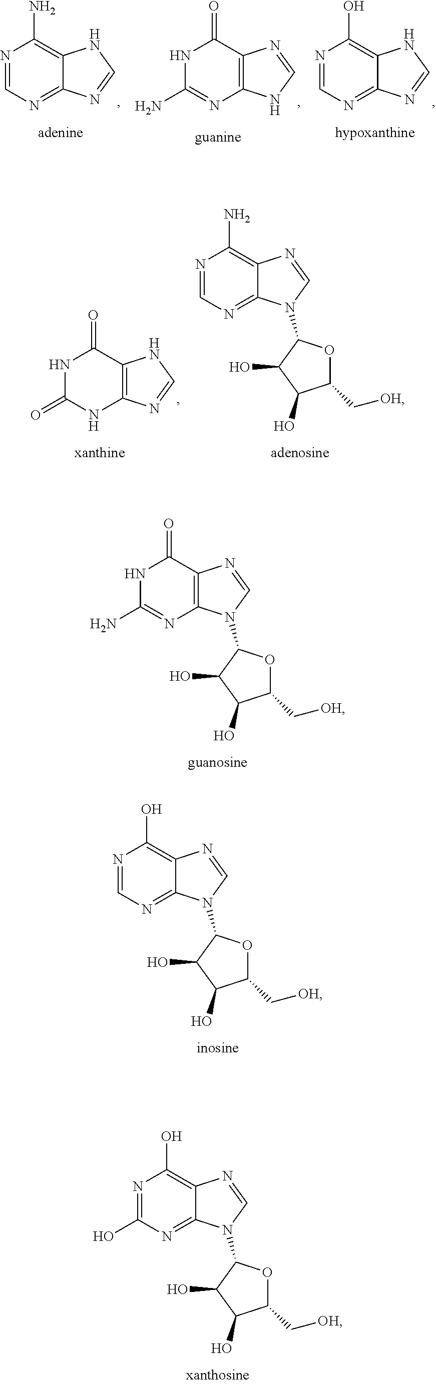

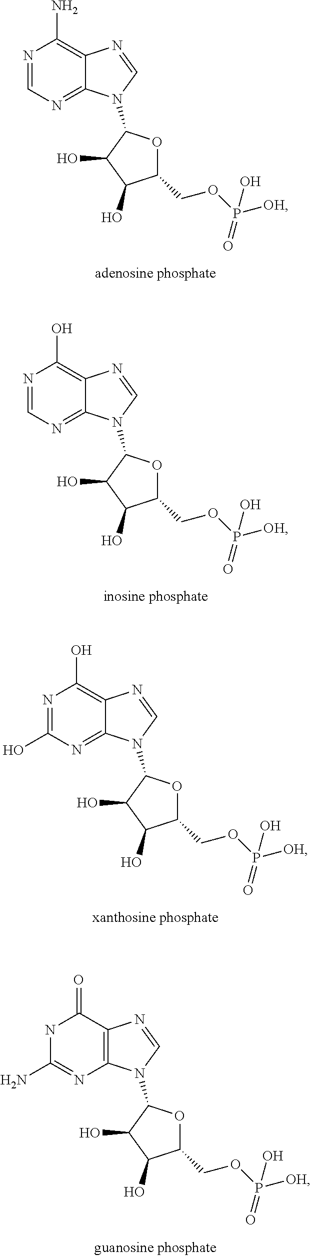 [SMILES: Nc1ncnc2c1ncn2[C@@H]1O[C@H](COP(=O)(O)O)[C@@H](O)[C@H]1O ; O=P(O)(O)OC[C@H]1O[C@@H](n2cnc3c(O)ncnc32)[C@H](O)[C@@H]1O ; O=P(O)(O)OC[C@H]1O[C@@H](n2cnc3c(O)nc(O)nc32)[C@H](O)[C@@H]1O ; Nc1nc2c(ncn2[C@@H]2O[C@H](COP(=O)(O)O)[C@@H](O)[C@H]2O)c(=O)[nH]1]

or a combination thereof.

In some embodiments, the removed purine can be at least one or various combinations of the above described purines.

In some embodiments, least about 40% of the original purine is removed from the complex mixture. In some embodiments, at least about 50%, at least about 60%, at least about 70%, at least about 80%, at least about 90%, at least about 95%, or at least about 97.5% of the original purine is removed from the complex mixture.

In some embodiments, the remaining purine levels can be less than and/or at most 40% of the original purine levels. In some embodiments, the remaining purine levels can be less than about 30%, less than about 20%, less than about 10%, less than about 5%, or less than about 2.5% of the original purine level in the complex mixture.

In some embodiments, the remaining purine levels in the purine removed complex liquid can be less than 0.005 mg per 100 ml (50 ppb), no more than about 0.5 mg per 100 ml (5 ppm), 1 mg per 100 ml (10 ppm), less than about 5 mg per 100 ml (50 ppm), less than about 100 mg per 100 ml (100 ppm), less than about 25 mg per 100 ml (250 ppm), or less than about 30 mg per 100 ml (300 ppm).

In some embodiments, the ratio of the amount of a purine removed to the amount of another compound removed, such as a flavor compound, is at least about 10 (10 mg of purine removed to 1 mg of another compound is a ratio of 10), at least about 50, at least about 80, at least about 100, at least about 150, at least about 200, at least the 300, at least about 400, at least about 500, at least about 600, at least about 700, at least that 800, at least about 900, at least about 1,000, at least about 1,500, at least about 2,000, at least that 3,000, at least about 4,000, at least about 5,000, at least about 6,000, at least about 7,000, at least about 8,000, at least that 9,000, at least that 10,000, at least about 20,000, at least about 30,000, at least about 40,000, at least that 50,000, at least not 60,000, at least about 70,000, at least about 80,000, at least about 90,000, at least about 100,000, at least about 1,000,000, or at least about 10,000,000, about 10-100, about 100-500, about 500-1,000, about 1,000-2,000, about 2,000-3,000, about 3,000-4,000, about 4,000-5,000, about 5,000-6,000, about 6,000-7,000, about 7,000-8,000, about 8,000-9,000, about 9,000-10,000, about 10,000-20,000, about 20,000-30,000, about 30,000-40,000, about 40,000-50,000, about 50,000-60,000, about 60,000-70,000, about 70,000-80,000, about 80,000-90,000, about 90,000-100,000, about 100,000-200,000, about 200,000-300,000, about 300,000-400,000, about 400,000-500,000, about 500,000-600,000, about 600,000-700,000, about 700,000-800,000, about 800,000-900,000, about 900,000-1,000,000, or about 1,000,000-10,000,000.

In some embodiments, the purine removed complex liquid can comprise at least 50%, 60%, 70%, 80%, 90%, or 95% of an original amount of a second compound in the complex liquid mixture. In some embodiments, the second compound can be a non-purine compound.

In some embodiments, the second compound can be a noted flavor complex mixture compound. In some embodiments, the noted flavor complex compound can be selected from at least one of carbohydrates, maltose, isoamyl acetate, ethyl acetate, iso-alpha acids, e.g., isohumulone, trans-isohumulone, trans-isocohumulone, trans-isoadhumulone, etc.), and/or other flavor esters:

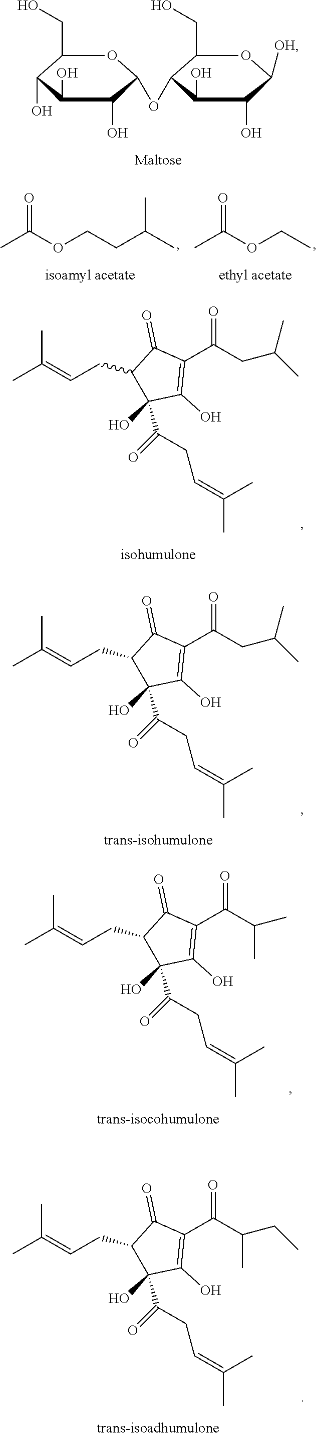

Some embodiments include a purine affinity polymer composite material. In some examples, the affinity polymer composite material can comprise a first monomer (or cross-linking monomer). In some cases the purine affinity composite material can comprise about 100 mol % to about 10 mol % cross-linking monomer. In some embodiments, a polymer composite is made of substantially only one selected monomer, meaning that the cross-linking monomer is cross-linking with itself. In some embodiments, the cross-linking monomer composite comprises at least one compound having two or more ethenyl or polymerizable moieties. In some embodiments, the ethenyl group is a vinyl group. In some examples, the ethenyl group is part of a substituted vinyl group. In some cases, the substituted vinyl group is substituted at the internal carbon atom, and not at the terminal carbon atom. In some embodiments, the ethenyl group is part of an acryloyl group. In some cases, the acryloyl group may be linked from its carbonyl group to an oxygen atom, thereby forming an acrylic ester compound, commonly referred to as an acrylate. In other embodiments, the acryloyl group may be linked from its carbonyl group to a nitrogen atom, thereby forming an acrylic amide compound, which is commonly termed an acrylamide. In some embodiments, the ethenyl group is part of a methacryloyl group moiety. In some examples, the methacryloyl group may be linked from its carbonyl group to an oxygen atom, thereby forming a methacrylic ester compound, commonly referred to as a methacrylate. In at least one other embodiment, the methacryloyl group may be linked from its carbonyl group to a nitrogen atom, thereby forming a methacrylic amide compound, which is commonly termed a methacrylamide.

In some embodiments, the cross-linking monomer can have at least two polymerizable ethenyl groups. In some embodiments, the polymerizable groups can be acrylate groups, acrylamide groups, methacrylate groups, methacrylamide groups, or any combination thereof. In some embodiments, the cross-linking monomer can comprise a substituted acrylate group, e.g., a methacrylate group. In some embodiments, the cross-linking monomer can comprise an acrylamide group.

In some embodiments, the cross-linking monomer can be a monomer of the formula:

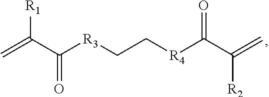

wherein R₁ and R₂ are independently —H or —CH₃; and R₃ and R₄ are independently N(H) or O. In some embodiments, the cross-linking monomer can be a monomer comprising:

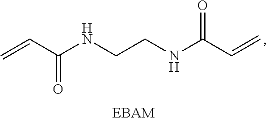

or 1,2-ethylene bisacrylamide (EBAM) [also known as N,N′-(ethane-1,2-diyl)diacrylamide or bisacyrlamide ethane (BAE)];

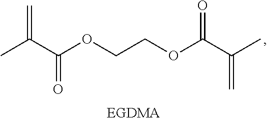

or ethylene glycol dimethacrylate (EDGMA) [also known as ethane-1,2-diyl bis(2-methylacrylate)];

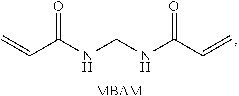

or methylene bisacrylamide (MBA), [also known as N,N′-methylenediacrylamide];

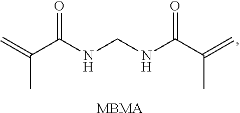

or methylene bismethacrylamide (MBMA), [also known as N,N′-methylenebis-(2-methacrylamide)];

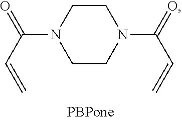

or 1,1′-(piperazine-1,4-diyl)bis(prop-2-en-1-one) (PBPone);

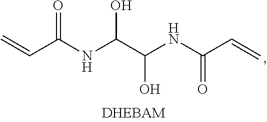

or 1,2-dihydroxyethyl-bisacrylamide (DHEBAM) [also known as N,N′-(1,2-dihydroxyethane-1,2-diyl)diacrylamide];

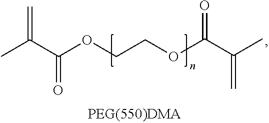

or polyethylene glycol(dimethacrylate), which has an average Mₙ of 550;

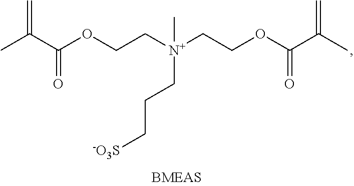

or 3-(bis(2-(methacryloyloxy)ethyl)(methyl)ammonio)propane-1-sulfonate (BMEAS); or any combination thereof.

In some embodiments, the cross-linking monomer can comprise an unsaturated phosphoric acid ester monomer. In some embodiments, the cross-linking unsaturated phosphoric acid monomer has the formula:

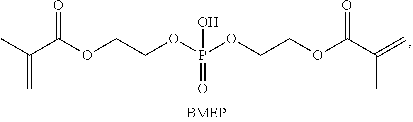 [SMILES: C=C(C)C(=O)OCCOP(=O)(O)OCCOC(=O)C(=C)C]

or ((hydroxyphosphoryl)bis(oxy))bis(ethane-2,1-diyl) bis(2-methylacrylate) (BMEP). In some embodiments the cross-linking unsaturated phosphoric acid monomer comprises a substituted BMEP.

In some embodiments, the cross-linking monomer can be a monomer of the formula:

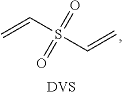

or divinylsulfone (DVS); or

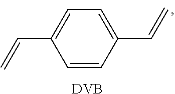

or divinylbenzene (DVB).

In some embodiments, the cross-linking monomer can have more than two ethenyl groups. In some examples, the unsaturated cross-linking monomer can have three ethenyl moieties. In some cases, the cross-linking unsaturated monomer has the formula:

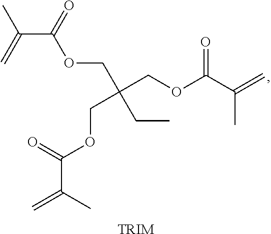

known as TRIM, or 2-ethyl-2-((methacryloyloxy)methyl)propane-1,3-diyl bis(2-methylacrylate).

In some embodiments, the affinity polymer composite material can comprise substantially only BMEP. In some embodiments, the affinity polymer composite material can be a monomer of BMEP.

In some embodiments, the purine affinity polymer composite material can comprise 0, 1, 2, 3, 4, or 5 second monomer components. In some examples, the second monomer component can comprise about 10 mol % to about 90 mol % of the purine affinity polymer composite. In some cases, the second monomer component comprises one ethenyl group or polymerizable moiety. In some embodiments, the second monomer component or moiety can comprise a boronic acid group. In some examples, the second monomer component or moiety can comprise a sulfonic acid group. In some cases, the second monomer component comprises a sulfonic acid salt, such as —SO₃K, —SO₃Na, or —SO₃NR₄. In some embodiments, the ethenyl group can be an acrylamide group. In other embodiments, the ethenyl group can be an acrylate group. In some examples, the ethenyl group can be a vinyl group.

In some embodiments, the second unsaturated monomer component has the formula:

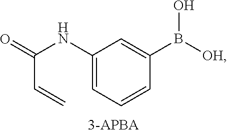

or 3-APBA or 3-acrylamidophenylboronic acid (3APBA);

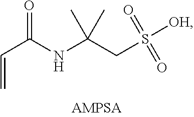

or 2-acrylamido-2-methyl-propane-1-sulfonic acid (AMPSA);

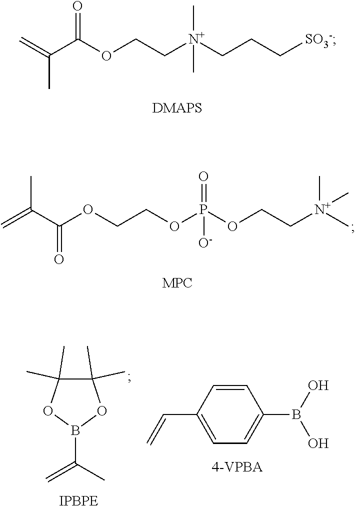

or 4-vinylphenylboronic acid (4-VPBA);

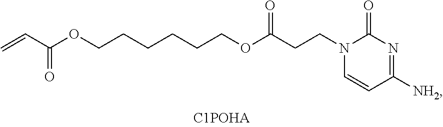 [SMILES: C=CC(=O)OCCCCCCOC(=O)CCn1ccc(N)nc1=O]

or 6-((3-(4-amino-2-oxopyrimidin-1(2H)-yl)propanoyl)oxy)hexyl acrylate (C1POHA);

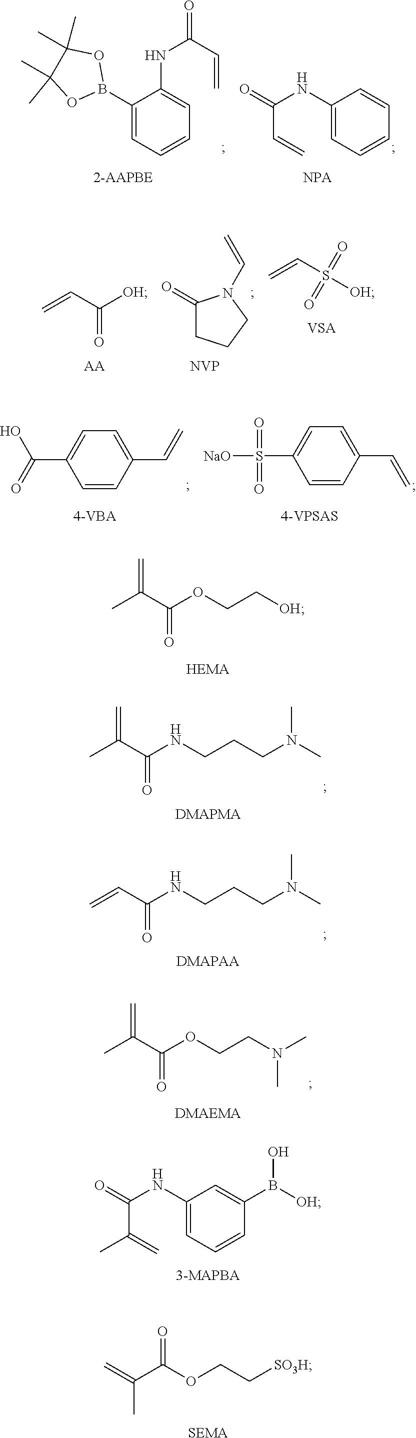

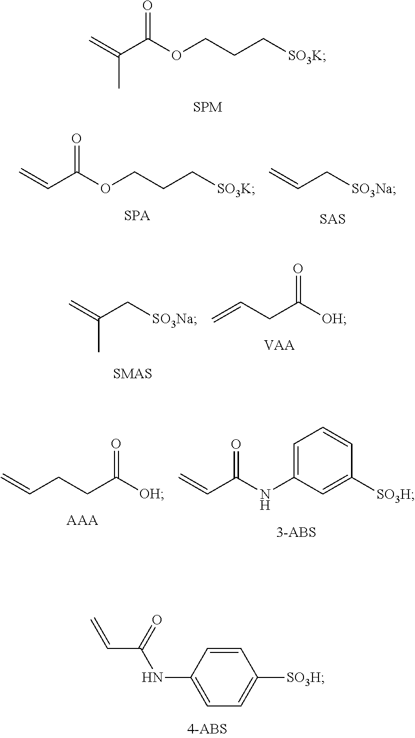

or any combination thereof.

In some examples, the second monomer (such as IPBPE or 2-AAPBE, above) contains a protected boronic acid group, which is deprotected in a step subsequent to polymerization to reveal the desired boronic acid functional group.

In some embodiments, the affinity composite material can comprise BMEP and at least a second monomer compound. In some embodiments, the second monomer compound can be 3-APBA.

In some embodiments, the acidic monomer component and/or the cross-linking monomer component have a differential binding energy between the purine compound and at least one or plural flavor compounds. In some embodiments, the first binding energy can be of a purine compound. In some embodiments the first binding energy can be that of guanine and/or guanosine. In some embodiments, the binding energies of the purine compound and the at least one flavor compound can be at least about 0.5 kcal/mol, at least about 0.7 kcal/mol, at least about 1 kcal/mol, at least about 1.5 kcal/mol, at least about 3 kcal/mol, at least about 5 kcal/mol, at least about 10 kcal/mol, at least about 15 kcal/mol, at least about 20 kcal/mol, at least about 25 kcal/mol, at least about 30 kcal/mol, at least about 35 kcal/mol, or at least about 40 kcal/mol different. In some embodiments, the binding energy of guanosine and at least one flavor compound selected from maltose, ethyl acetate, isoamyl acetate and/or iso alpha acid are at least about 0.5 kcal/mol, at least about 0.7 kcal/mol, at least about 1 kcal/mol, at least about 1.5 kcal/mol, at least about 3 kcal/mol, at least about 5 kcal/mol, at least about 10 kcal/mol, at least about 15 kcal/mol, at least about 20 kcal/mol, at least about 25 kcal/mol, at least about 30 kcal/mol, at least about 35 kcal/mol, or at least about 40 kcal/mol different. For the purposes of this disclosure, it is understood that the purine affinity polymer composite more favorably interacts with or binds to purine compounds, and does not interact nor bind as favorably to the flavor compounds of the complex mixtures. Thus, the purine affinity polymer composite removes purines while leaving flavor compounds intact in the complex mixture.

In some embodiments, the cross-linking monomer is substantially all of the affinity polymer composite. In some embodiments, the acidic monomer is substantially all of the affinity polymer composite. In some embodiments, the ratio of the first or cross-linking monomer to the second or acidic monomer can be between about 100% to about 10% (cross-linking monomer) to about 0% to about 90% acidic monomer. In some embodiments, the percentage is in terms of wt %. In some embodiments, the percentage is in terms of mol %.

Some embodiments include a prepolymerization solution (PPS). In some embodiments, the prepolymerization solution can be utilized to create the affinity polymer composite. In some embodiments, a radical polymerization initiator can be added to the PPS. In some embodiments, the radical initiator can be azobisisobutyronitrile (AIBN). In some embodiments, the amount of the radical initiator in the composite material can be between about 0.000001 mol % to about 10 mol %, about 0.1-0.2 mol %, about 0.2-0.3 mol %, about 0.3-0.4 mol %, about 0.4-0.5 mol %, about 0.5-0.6 mol %, about 0.6-0.7 mol %, about 0.7-0.8 mol %, about 0.8-0.9 mol %, about 0.9-1 mol %, about 0.4 mol %, about 0.6 mol %, about 0.8 mol %, or about 1 mol %.

In some examples, the prepolymerization solution comprises a solvent. In some embodiments, the solvent can be a polymerizable compound, such as an acrylate which exists as a liquid at standard temperature and pressure. In some embodiments, no additional solvent may be added. In some embodiments, a solvent can be included in the prepolymerization solution. In some embodiments, the solvent can be any suitable solvent, e.g., polar and/or a non-polar solvent. In some embodiments, the solvent can be water. In some examples, the solvent can be methanol, ethanol, or another simple alcohol. In some embodiments, the solvent can be aprotic. In some embodiments, the solvent can be a combination of any miscible or immiscible solvents. In some embodiments, the solvent can be any combination of alcohols and N-methylpyrrolidone (NMP). In some embodiments, the solvent can be aprotic (DMSO, hexane, THF, NMP). In some embodiments, the solvent can comprise a polar aprotic organic solvent. In some embodiments, the polar aprotic organic solvent can be NMP, and/or dimethylsulfoxide (DMSO). In some embodiments, the solvent can further comprise a surfactant or mixture of surfactants in addition to two immiscible solvents, such that the polymerizable solution can exist as suspended droplets in a continuous phase. In some embodiments, the amount of the solvent can be between about 0.01 mol % to about 99.9 mol %, e.g., 1 mL NMP.

In some embodiments, the PPS can further comprise a purine, such as guanosine. The guanosine may be present in about 0.1-10 mol %, about 0.1-1 mol %, about 1-2 mol %, about 2-3 mol %, about 3-4 mol %, about 4-5 mol %, about 5-6 mol %, about 6-7 mol %, about 7-8 mol %, about 8-9 mol %, about 9-10 mol %, about 1 mol %, about 2 mol %, about 3 mol %, about 4 mol % or about 5 mol %. It is believed that the presence of guanosine during polymer composite formation may impart an imprint of a guanosine binding pocket into the polymer composite. It is thought that a receptor pocket is formed around the guanosine during polymerization. Once polymerization of the PPS is complete, the guanosine is removed in an acid wash, leaving behind a pocket for retention of guanosine (or other purine compound) in the affinity polymer composite.

Some embodiments include a filtration medium comprising the affinity polymer composite. Some embodiments include a chromatographic element comprising the affinity polymer composite. In some embodiments, the filtration medium or chromatographic element can be a resin, a plate, a column, or a substrate comprising at least one of a purine affinity polymer composite described herein. In some embodiments, the filtration or chromatography resin can comprise a column matrix for purine imprinted interaction chromatography. In some embodiments, the affinity polymer composite material by itself can be the solid phase material. In some embodiments, the solid phase filtration of chromatography material can comprise an additional matrix or support material, wherein the affinity polymer composite described herein is bound or attached thereto. In some embodiments, the column matrix can be selected from silica, alumina, phenyl sepharose, butyl sepharose, octyl sepharose, and/or phenyl sepharose.

Some embodiments include a chromatographic membrane or layer. In some embodiments, the chromatographic membrane can comprise at least one of the affinity polymers described herein.

In some embodiments, a method for reducing purine levels in mixed liquid is described, the method can comprise providing a complex mixed solution with a purine level and contacting a purine affinity polymer composite with the solution. In some embodiments, contacting a purine affinity polymer composite includes passing the complex solution over, past and/or through a chromatographic element, e.g., resins, plates, columns or membranes containing the purine affinity polymer composite which can selectively retain the purine compound while enabling the rest of the complex solution and compounds or materials contained therein to pass therethrough or thereby. In some embodiments, the solution can be a wort. In some embodiments, the solution can be a beer. In some embodiments, the wort and/or beer can be undiluted. In some embodiments, the resultant wort and/or beer, e.g., the solution with the desired purine material removed, can be utilized in typical brewing process. In some embodiments, the method can further comprise removing the purine affinity polymer composite from the solution. In some embodiments, contacting the purine affinity polymer composite can comprise loading a column with the purine affinity polymer composite and passing the provided solution therethrough. In some embodiments, contacting the purine affinity polymer composite can comprise providing a membrane comprising the purine affinity polymer composite and contacting the provided solution thereto. In some embodiments, contacting the provided solution can comprise passing the complex solution through the membrane. In some embodiments, contacting the provided solution can comprise passing the complex solution by and/or over and/or past the membrane. In some embodiments, the complex mixture can be a beer or wort. In some embodiments, the purine can be selected from adenine, adenosine, guanine, guanosine, hypoxanthine, inosine, xanthosine, xanthine, adenosine phosphate, guanosine phosphate, inosine phosphate, and/or xanthosine phosphate, and or combinations or mixtures thereof.

Some embodiments include a method for removing purines from a complex mixture. Such a method can comprise providing a purine affinity polymer composite stationary phase configured to retain a purine; and passing a complex mixture as a mobile phase through the purine affinity polymer composite stationary phase to remove the purine from the complex mixture. In some embodiments, the initial purine wort or beer concentration can be about 50 ppm. In some embodiments, the residual beer or wort purine concentration is less than 40 ppm, less than 35 ppm, less than 30 ppm, less than 25 ppm, less than 10 ppm, less than 5 ppm, and/or less than 3.5 ppm. In some embodiments, the initial flavor compound concentration in the beer or wort can be about 50 ppm. In some embodiments, the residual beer or wort flavor compound concentration can be greater than 20%, greater than 30%, greater than 40%, greater than 50%, greater than 60%, greater than 70%, greater than 80%, greater than 90% of the initial concentration. In some embodiments, a purine affinity polymer composite stationary phase can comprise a purine affinity polymer composite as described herein, and a polymer bead. In some embodiments, the purine affinity polymer composite can be attached to a polymer bead. In some embodiments, the purine affinity polymer composite can be attached to a substrate for passing the mobile phase over, by the stationary phase. In some embodiments, the substrate can be a column wall, chromatographic plate and/or a membrane surface. The polymer bead can be a sepharose polymer described earlier herein. In some embodiments, the complex mixture can be a beer or wort solution. In some embodiments, the beer or wort can be undiluted or substantially undiluted. In some embodiments, substantially undiluted can be diluted less than 10%, less than 5%, or less than 2.5%. In some embodiments, the purine can be selected from adenine, adenosine, guanine, guanosine, hypoxanthine, inosine, xanthosine or xanthine. In some embodiments, the purine can be guanine. In some embodiments the purine removed can be a first purine, the first purine removed level can be greater than 40%, while the concurrent removal of a second material or molecule is less than 10%. In some embodiments, the second material which may not be removed may be at least one of the aforementioned flavor components. In some embodiments, the purine level of the resultant passed complex mixture can less than 1 mg per 100 mL or those levels described elsewhere herein. In some embodiments, the reduced levels are achieved within 6 hours, 12 hours, 24 hours, 48 hours, or 72 hours.

### EXAMPLES

It has been discovered that embodiments of processes and/or constructs using or incorporating the purine affinity polymers describe herein reduce the levels of purine compounds contained within the complex solution without concurrently removing other materials therein, e.g., flavor compounds, etc. These benefits are further shown by the following examples, which are intended to be illustrative of the embodiments of the disclosure, but are not intended to limit the scope or underlying principles in any way.

Most pertinent monomers, purines and flavor compounds were commercially available, e.g., Sigma Aldrich, St. Louis Mo., USA, TCI America, Combi-blocks. Monomers that were not commercially available, or not available at the purity desired, were prepared as shown below.

### Example 1—Synthesis of Monomers

### Synthesis of 2-acrylamidoethyl acrylate (2-AAEA)

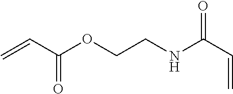

To a 200 mL round bottom flask equipped with a magnetic stir bar and a rubber septum cap, was added ethanolamine (3 mL, 3 g, 50 mmol), water (15 mL), acetonitrile (45 mL), and sodium hydroxide (6.5 g, 160 mmol, 3.3 equivalents). Upon addition of sodium hydroxide, a biphasic mixture was noted. After both layers of the solution became clear and colorless, the flask was placed in a water ice bath to bring the temperature of the solution to near 0° C. Acryloyl chloride (9 mL, 110 mmol, 2.2 equivalents) was taken up in a syringe and added to the cold stirring solution through the septum in a drop-wise fashion. The addition of acryloyl chloride was complete after 17 minutes. The reaction flask was left in the ice bath for 2 hours, and then it was removed from the ice bath and allowed to stir at room temperature for overnight. The contents of the reaction vessel were transferred to a separatory funnel containing enough water to dissolve the white salts that were formed during the reaction. The organic products were extracted with dichloromethane in 3 portions of about 150 ml each. Then, to the aqueous portion was added solid sodium chloride until it was almost saturated. The brined aqueous layer was further extracted with 3 more 100 mL portions of dichloromethane. Then, the pooled dichloromethane portions were washed with a saturated sodium bicarbonate solution (about 100 mL), followed by a brine wash (about 50 mL). Following the brine wash, the pooled dichloromethane extract was dried over solid magnesium sulfate, filtered, and concentrated to dryness on a rotary evaporator. The crude product was 3.42 grams of a yellow-orange oil. The crude product was diluted with a minimal amount of dichloromethane and added via pipette to the top of a silica gel column which had been prepared and equilibrated with 1:1 ethyl acetate:hexane. The column diameter was about 2 inches and the amount of silica used was about 100-150 grams. The product was eluted from the column by increasing the polarity of the mobile phase from 1:1 ethyl acetate:hexane up to 4:1 ethyl acetate:hexane over about 1.2 liters of mobile phase flow-through. Column fractions of about 40 mL each were collected and analyzed by thin layer chromatography. Fractions containing the expected product were pooled and to the pooled product fractions was added 0.3 milliliters of a 1 mg/ml solution of 4-methoxyphenol (MEHQ) in methanol, as a polymerization inhibitor. The pooled fractions containing the 300 micrograms of MEHQ were concentrated to dryness on a rotary evaporator to yield 2.9 g of 2-acrylamidoethyl acrylate as a colorless oil stabilized with 103 ppm MEHQ.

### Synthesis of 2-acrylamidopyridine

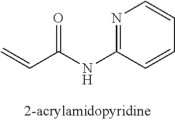

To a 200 mL 1-neck round bottom flask was added 2-aminopyridine (1.00 g, 10.6 mmol), dichloromethane (DCM) (100 mL), and triethylamine (1.50 mL, 10.6 mmol) and a Teflon-coated magnetic stir bar. The solution was cooled to −78° C. by placing the reaction vessel into a dry ice/acetone bath before dropwise addition of acryloyl chloride (0.87 mL, 10.7 mmol), at which point the solution changed from transparent colorless to transparent bright yellow. After the addition, the solution was transferred to an aqueous ice bath and allowed to stir for two hours. During this time white precipitate formed in solution. After two hours, the ice bath was removed and the solution was allowed to warm to room temperature (23° C.) for an additional hour. The solvent was then removed through dynamic vacuum, and the dark yellow resin was extracted with DCM (8 mL). The extract was added to a flash column prepped with 40% ethyl acetate in hexanes, and the product was eluted using a 40% ethyl acetate in hexanes solution. Concentration with dynamic vacuum yielded the product 2-acrylamidopyridine as a light yellow solid (1.09 g, 69.4% yield). 1H NMR (400 MHz, Chloroform-d) δ 9.00 (s, 1H), 8.32 (dd, J=16.5, 6.6 Hz, 2H), 7.74 (t, J=7.8 Hz, 1H), 7.13-7.00 (m, 1H), 6.49 (d, J=16.9 Hz, 1H), 6.30 (dd, J=16.9, 10.2 Hz, 1H), 5.81 (d, J=10.2 Hz, 1H). 13C NMR (101 MHz, CDCl3) δ 163.94, 151.75, 147.82, 138.71, 131.10, 128.68, 120.09, 114.77.

### Synthesis of N,N′-(ethane-1,2-diyl)diacrylamide or 1,2-bis(acrylamide)ethane (EBAM)

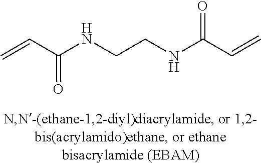

To a 200 mL, 1-neck round bottom flask, equipped with a Teflon-coated magnetic stir bar was added acetonitrile (60 mL), deionized H2O (20 mL), ethylene diamine (3.6 mL, 53.9 mmol), and sodium hydroxide (9.01 g, 225.3 mmol). The reaction flask was placed into an ice bath and cooled to 0° C. before the dropwise addition of acryloyl chloride (15.0 mL, 185.4 mmol) over a 20 minute period. After the addition, the white precipitate began to form in the transparent colorless solution, and the reaction flask was removed from the ice bath and allowed to gradually warm to room temperature (23° C.). The reaction was stirred for 4 h and 45 minutes, then the acetonitrile was separated from the aqueous fraction, and evaporated through dynamic vacuum leaving behind a white solid. Extraction with DCM (7×50 mL) provided a colorless organic fraction with an insoluble white solid. The solid was removed through filtration, and the organic fraction dried over sodium sulfate. Removal of the sodium sulfate through vacuum filtration and the DCM through dynamic vacuum left behind a white solid, which was poorly soluble in DCM, slightly soluble in H2O, and very soluble in methanol. Both the extracted white solid, and the material removed through filtration were analyzed with NMR and determined to be the product N,N′-(ethane-1,2-diyl)diacrylamide. Drying under high vacuum provided a white crystalline solid (5.13 g, 56.6% yield). 1H NMR (400 MHz, Chloroform-d) δ 6.82 (s, 2H), 6.27 (d, J=17.0 Hz, 2H), 6.13 (dd, J=17.0, 10.2 Hz, 2H), 5.66 (d, J=10.2 Hz, 2H), 3.57-3.45 (m, 4H). 13C NMR (101 MHz, CDCl3) δ 167.08, 130.76, 126.89, 40.22.

### Synthesis of 6-((3-(4-amino-2-oxopyrimidin-1(2H)-yl)propanoyl)oxy)hexyl acrylate (C1POHA)

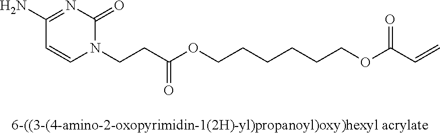 [SMILES: C=CC(=O)OCCCCCCOC(=O)CCn1ccc(N)nc1=O]

To a 20 mL glass scintillation vial, equipped with a Teflon-coated magnetic stir bar was added cytosine (1 g, 9 mmol), methyl ether hydroquinone (MEHQ) (0.193 g, 1.55 mmol), 1,6-hexanediol diacrylate (3 mL, 13.39 mmol), and diisopropylethylamine (0.53 mL, 3.04 mmol) creating a white slurry. The vial was capped with a drying tube and the solution heated to 50° C. with stirring for 44 h by which time most of the solids had dissolved into solution. After 44 h, the solution was removed from heat and diluted with deionized (DI) H₂O (100 mL) at which point a white precipitate formed which was too small to collect through filtration. The aqueous solution was extracted with hexanes (3×100 mL), then dichloromethane (2×100 mL). The dichloromethane fractions were combined and dried over magnesium sulfate. Removal of the dichloromethane through dynamic vacuum left behind a yellow residue. The residue was purified via flash chromatography using dichloromethane with 1% methanol. After solvent removal and further drying under high vacuum, the product was isolated as a white waxy solid 0.678 g, 22.3% yield. 1H NMR (400 MHz, DMSO-d6) δ 7.52 (d, J=7.2 Hz, 1H), 7.00 (d, J=27.3 Hz, 2H), 6.31 (d, J=17.1 Hz, 1H), 6.17 (dd, J=17.3, 10.3 Hz, 1H), 5.93 (d, J=10.3 Hz, 1H), 5.60 (d, J=7.2 Hz, 1H), 4.09 (t, J=6.5 Hz, 2H), 4.00 (t, J=6.5 Hz, 2H), 3.82 (t, J=6.6 Hz, 2H), 2.66 (t, J=6.6 Hz, 2H), 1.56 (dq, J=19.5, 6.4 Hz, 4H), 1.37-1.20 (m, 4H). 13C NMR (101 MHz, DMSO) δ 171.09, 166.07, 165.54, 155.61, 146.45, 131.37, 128.41, 93.02, 64.02, 63.99, 45.36, 32.83, 27.97, 27.93, 25.03, 24.99.

### Synthesis of N,N′-(pyridine-2,6-diyl)diacrylamide

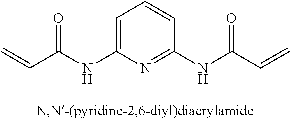 [SMILES: C=CC(=O)Nc1cccc(NC(=O)C=C)n1]

To a 100 mL one neck round bottom flask, equipped with a Teflon-coated magnetic stir bar was added 2,6-diaminopyridine (3.63 g, 33.33 mmol), acetonitrile (30 mL), and deionized H₂O (20 mL). The reaction flask was placed into an ice bath and cooled to 0° C. before the addition of sodium hydroxide (4.487 g, 112.17 mmol). The solution was then allowed time to return to 0° C. before the dropwise addition of acryloyl chloride (6 mL, 73.85 mmol), which was added over a 20-minute period of time. After 10 minutes of stirring, the reaction vessel was removed from the ice bath and allowed to warm to room temperature (23° C.), and then stirred at this temperature for 4 hours during which time a precipitate formed in solution. The precipitate was isolated through filtration and washed with deionized water (4×50 mL) then dried under vacuum to yield a light tan powder (1.273 g, 17.6%). 1H NMR (400 MHz, DMSO-d⁶) δ 10.32 (s, 1H), 7.93-7.73 (m, 1H), 6.66 (dd, J=17.0, 10.2 Hz, 1H), 6.31 (d, J=17.0 Hz, 1H), 5.78 (d, J=10.3 Hz, 1H). 13C NMR (101 MHz, DMSO) δ 164.18, 150.80, 140.56, 132.04, 128.25, 110.28.

### Example 2—Determination of Monomer Binding Energies

Molecular modelling was performed for the target (guanosine) and several flavor compounds (alpha and beta maltose, ethyl acetate, isoamyl acetate, trans-isocohumulone, trans-isoadhumulone, trans-isohumulone). The molecular modelling was done using the software package SYBYL 7.0 (Tripos, Inc, St. Louis, Mo., USA). Molecular modelling and Leapfrog algorithm were used for the calculation of binding affinities between monomers, e.g., bis(methacryloyloxyethyl)phosphate (BMEP, CAS No. 32435-46-4 from Sigma Aldrich), and the flavor compounds as well as with the target compound guanosine. Three dimensional structures were downloaded from PubChem database. The molecules were then checked for atom types, chirality and charge using Gasteiger-Huckel method (software package SYBYL). A molecular mechanics method was applied for a total of 1000 iterations to perform an energy minimization with the Powell method to obtain the lowest configuration for each molecule. The resulting structures were screened against the BMEP monomer using the Leapfrog algorithm. The screening was performed for 5,000,000 iterations to determine the binding energies between guanosine and the BMEP monomer, and the flavor molecules and the BMEP monomer. The results (kcal/mol) are shown in Table 1.

TABLE 1
Binding energies.

| | Flavor Compounds | | | | | | |
|---|---|---|---|---|---|---|---|
| Target | α- | β- | Ethyl | Isoamyl | Trans- | Trans- | Trans- |
| Guanosine | maltose | maltose | acetate | acetate | isocohumulone | isoadhumulone | isohumulone |
| −46.2 | 8.65 | 8.75 | 24.87 | 23.7 | 27.5 | 19.23 | 28.42 |

Based on the above results, BMEP was selected as a suitable monomer candidate.

### Example 3—Synthesis of Affinity Polymer Composite Embodiments

### Synthesis of Affinity Polymer-1A (AP-1A)

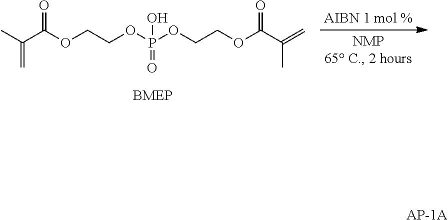 [SMILES: C=C(C)C(=O)OCCOP(=O)(O)OCCOC(=O)C(=C)C ; "AP-1A"]

Bis(methacryloyloxyethyl)phosphate (BMEP, 1 g, 3.1 mmol), AIBN (5.1 mg), and N-methylpyrrolidinone (5 mL) were combined in an 8 mL glass vial with a screw cap. The homogeneous solution was degassed by bubbling argon into the liquid through a needle for 2 minutes. As soon as the needle was removed from the vial, the screw cap was fastened to seal the vessel. The vial containing the degassed pre-polymerization solution was placed in an aluminum heating block supported by a hot plate, which had been pre-heated to 65° C. The vial was stored in the 65° C. heating block for 2 hours, after which a monolithic polymer gel was obtained. The polymer gel was scraped out of the vial using a spatula and transferred into a 250 mL Erlenmeyer flask containing a magnetic stir bar and 200 mL of 1:1 methanol:water and the mixture was stirred for overnight. The solids were separated from the liquid by transferring the mixture into 50 mL conical centrifuge vials, then centrifuged at about 3,000 RPM for about 5 minutes. The supernatant was discarded and the solid pellets were transferred back into a 250 ml Erlenmeyer flask containing 200 mL of 1:1 methanol:water. After about 2 hours of stirring, the mixture was centrifuged again using the same conditions. The resulting pellets were re-dispersed in pure methanol for a final wash prior to their final centrifugation. The solids were stirred in methanol for about an hour, after which the final centrifugation was performed, and then after discarding the supernatant liquid, the solid pellets were dried in a vacuum oven at about 60° C. for overnight. The dried solids were collected and ready to be used as a solid phase extraction material.

### Synthesis of Affinity Polymer-1B (AP-1B)

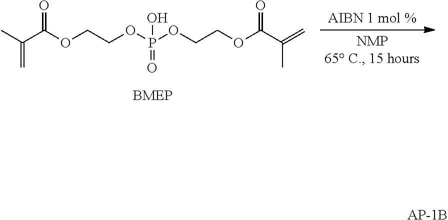 [SMILES: C=C(C)C(=O)OCCOP(=O)(O)OCCOC(=O)C(=C)C ; "AP-1B"]

Bis(methacryloyloxyethyl)phosphate (1 g), AIBN (5.1 mg), and N-methylpyrrolidinone (5 mL) were combined in a 20 ml glass vial with a screw cap. The solution was degassed by bubbling argon into the liquid through a needle for 150 seconds. After the needle was removed, the screw cap was immediately secured on the vial to make a seal. The vial was then placed in an aluminum heating block supported by a hot plate, and then the hot plate was heated to 65° C. The temperature was maintained for 15 hours, and then the resulting polymer gel was scraped out of the vial using a spatula and transferred into a 250 mL Erlenmeyer flask containing a magnetic stir bar and 200 mL of 1:1 methanol:water. The mixture was allowed to stir for a weekend, and then the solids were separated from the liquid by means of centrifugation at about 3000 RPM for about 5 minutes in 50 ml conical centrifuge vials. The supernatant was discarded, then the solids were re-dispersed in 200 ml of 1:1 methanol:water and stirred for 4 hours. Then, the solids were separated from the liquid by centrifugation at about 3,000 RPM for about 5 minutes. The supernatant was discarded and the pellets re-dispersed in 200 ml of 1:1 methanol:water. The mixture was stirred for overnight, then the solids were separated from the liquid by centrifugation using the same conditions. After discarding the supernatant, the solids were dispersed in 200 mL of pure methanol and stirred briefly. The solids were separated from the methanol by centrifugation using the same conditions. Then, after discarding the supernatant, the solids were rinsed one final time in their centrifuge vials with pure methanol, followed by the final centrifugation in the same conditions, then discarding the methanol and drying the pellets in a vacuum oven overnight at about 65-75° C. The dried polymer product was mechanically crushed, then collected and ready to be used as a solid phase extraction resin.

### Synthesis of Affinity Polymer-1C (AP-1C)

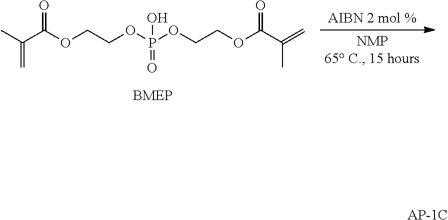 [SMILES: C=C(C)C(=O)OCCOP(=O)(O)OCCOC(=O)C(=C)C ; "AP-1C"]

Bis(methacryloyloxyethyl)phosphate (1 g), AIBN (10.2 mg), and N-methylpyrrolidinone (5 mL) were combined in a 20 mL glass vial with a screw cap. The solution was degassed by bubbling argon into the liquid through a needle for 150 seconds. After the needle was removed, the screw cap was immediately secured on the vial to make a seal. The vial was then placed in an aluminum heating block supported by a hot plate, and then the hot plate was heated to 65° C. The temperature was maintained for 15 hours, and then the resulting polymer gel was scraped out of the vial using a spatula and transferred into a 250 mL Erlenmeyer flask containing a magnetic stir bar and 200 mL of 1:1 methanol:water. The mixture was allowed to stir for a weekend, and then the solids were separated from the liquid by means of centrifugation at about 3000 RPM for about 5 minutes in 50 mL conical centrifuge vials. The supernatant was discarded, then the solids were re-dispersed in 200 mL of 1:1 methanol:water and stirred for 4 hours. Then, the solids were separated from the liquid by centrifugation at about 3,000 RPM for about 5 minutes. The supernatant was discarded and the pellets re-dispersed in 200 mL of 1:1 methanol:water. The mixture was stirred for overnight, then the solids were separated from the liquid by centrifugation using the same conditions. After discarding the supernatant, the solids were dispersed in 200 mL of pure methanol and stirred briefly. The solids were separated from the methanol by centrifugation using the same conditions. Then, after discarding the supernatant, the solids were rinsed one final time in their centrifuge vials with pure methanol, followed by the final centrifugation in the same conditions, then discarding the methanol and drying the pellets in a vacuum oven overnight at about 65-75° C. The dried polymer product was mechanically crushed, then collected and ready to be used as a solid phase extraction resin.

### Synthesis of Affinity Polymer-1D (AP-1D)

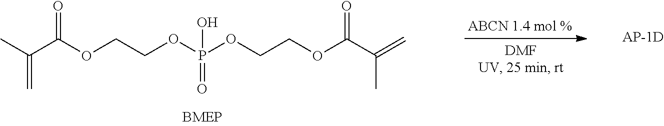 [SMILES: C=C(C)C(=O)OCCOP(=O)(O)OCCOC(=O)C(=C)C ; "AP-1D"]

Bis(methacryloyloxyethyl)phosphate, 18.3 g, (1,1′ mg)-azobis(cyclohexanecarbonitrile) (ABCN, 127 mg), and DMF (9.1 g) were added to a flask. The solution was vortexed and sonicated for a few seconds to obtain a homogeneous mixture. The polymerization mixture was then bubbled with nitrogen (g) for at least 5 minutes to remove dissolved oxygen, then transferred into 30 mL vials which were promptly closed under nitrogen with a screw cap and placed under a UV curing lamp for 25 minutes. The polymer monoliths were then ground on a centrifugal mill. The crushed polymer was then wet sieved with methanol, first on a sieve with 125 micron openings to remove large particles, onto a sieve with 45 micron openings to remove fine particulates, to afford a particle size between 45-125 microns (μm or micrometers). Finally, the 45-125 micron sized particles were then placed into an extraction thimble and washed for 24 hours on a Soxhlet extractor with methanol. This general method of refining the particle size of the crushed polymer was used in the examples below, occasionally replacing the sieve with 125 micron openings with a sieve having 150 micron openings.

### Synthesis of Affinity Polymer-2 (AP-2)

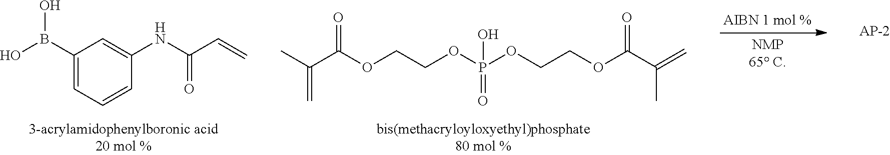

Bis(methacryloyloxyethyl)phosphate (1 g, 3.1 mmol), 3-acrylamidophenylboronic acid (125 mg), AIBN (6.1 mg), and N-methylpyrrolidinone (5 mL) were combined in an 8 mL glass vial with a screw cap. The homogeneous solution was degassed by bubbling argon into the liquid through a needle for 2 minutes. As soon as the needle was removed from the vial, the screw cap was fastened to seal the vessel. The vial containing the degassed pre-polymerization solution was placed in an aluminum heating block supported by a hot plate, which had been pre-heated to 65° C. The vial was stored in the 65° C. heating block for 2 hours, after which a monolithic polymer gel was obtained. The polymer gel was scraped out of the vial using a spatula and transferred into a 250 ml Erlenmeyer flask containing a magnetic stir bar and 200 mL of 1:1 methanol:water and the mixture was stirred for overnight. The solids were separated from the liquid by transferring the mixture into 50 mL conical centrifuge vials, then centrifuged at about 3,000 RPM for about 5 minutes. The supernatant was discarded and the solid pellets were transferred back into a 250 mL Erlenmeyer flask containing 200 mL of 1:1 methanol:water. After about 2 hours of stirring, the mixture was centrifuged again using the same conditions. The resulting pellets were re-dispersed in pure methanol for a final wash prior to their final centrifugation. The solids were stirred in methanol for about an hour, after which the final centrifugation was performed, and then after discarding the supernatant liquid, the solid pellets were dried in a vacuum oven at about 60° C. for overnight. The dried solids were collected and ready to be used as a solid phase extraction material.

### Synthesis of Affinity Polymer-3 (AP-3)

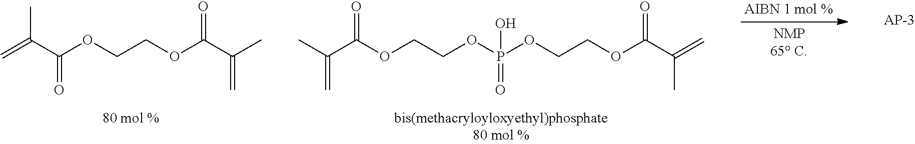

Bis(methacryloyloxyethyl)phosphate (340 mg), ethylene glycol dimethacrylate (0.95 mL), AIBN (10 mg), and N-methylpyrrolidinone (5 mL) were combined in an 8 ml glass vial with a screw cap. The homogeneous solution was degassed by bubbling argon into the liquid through a needle for 2 minutes. As soon as the needle was removed from the vial, the screw cap was fastened to seal the vessel. The vial containing the degassed pre-polymerization solution was placed in an aluminum heating block supported by a hot plate, which had been pre-heated to 65° C. The vial was stored in the 65° C. heating block for 2 hours, after which a monolithic polymer gel was obtained. The polymer gel was scraped out of the vial using a spatula and transferred into a 250 mL Erlenmeyer flask containing a magnetic stir bar and 200 mL of 1:1 methanol:water and the mixture was stirred for overnight. The solids were separated from the liquid by filtering the mixture through Whatman #1 filter paper in a Buchner funnel via vacuum filtration. The solids were crushed mechanically and then they were transferred back into a 250 mL Erlenmeyer flask containing 200 mL of 1:1 methanol:water. After about 2 hours of stirring, the solids were collected by centrifugation in 50 ml conical vials at about 3,000 RPM for about 5 minutes. After discarding the supernatant liquid, the resulting pellets were re-dispersed in 200 mL of 1:1 methanol:water and stirred. The solid-liquid separation was effected by centrifugation using the same conditions. The supernatant was discarded, and the solids were washed with pure methanol and vortexed, after which the final centrifugation was performed, and then after discarding the supernatant liquid, the solid pellets were dried in a vacuum oven at about 60C for overnight. The dried solids were collected and ready to be used as a solid phase extraction material.

### Synthesis of Affinity Polymer AP-4

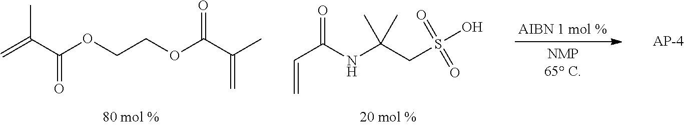

2-acrylamido-2-methyl-1-propane sulfonic acid (261 mg), ethylene glycol dimethacrylate (1 g), AIBN (10.3 mg), and N-methylpyrrolidinone (5 mL) were combined in a 20 mL glass vial with a screw cap. The mixture was homogenized by briefly exposing the vial to an ultrasonic bath. The solution was degassed by bubbling argon into the liquid through a needle for 150 seconds. After the needle was removed, the screw cap was immediately secured on the vial to make a seal. The vial was then placed in an aluminum heating block supported by a hot plate, and then the hot plate was heated to 65° C. The temperature was maintained for 15 hours, and then the resulting polymer gel was scraped out of the vial using a spatula and transferred into a 250 mL Erlenmeyer flask containing a magnetic stir bar and 200 mL of 1:1 methanol:water. The mixture was allowed to stir for a weekend, and then the solids were separated from the liquid by means of centrifugation at about 3000 RPM for about 5 minutes in 50 mL conical centrifuge vials. The supernatant was discarded, then the solids were re-dispersed in 200 mL of 1:1 methanol:water and stirred for 4 hours. Then, the solids were separated from the liquid by centrifugation at about 3,000 RPM for about 5 minutes. The supernatant was discarded and the pellets re-dispersed in 200 mL of 1:1 methanol:water. The mixture was stirred for overnight, then the solids were separated from the liquid by centrifugation using the same conditions. After discarding the supernatant, the solids were dispersed in 200 mL of pure methanol and stirred briefly. The solids were separated from the methanol by centrifugation using the same conditions. Then, after discarding the supernatant, the solids were rinsed one final time in their centrifuge vials with pure methanol, followed by the final centrifugation in the same conditions, then discarding the methanol and drying the pellets in a vacuum oven overnight at about 65-75° C. The dried polymer product was mechanically crushed, then collected and ready to be used as a solid phase extraction resin.

### Synthesis of Affinity Polymer AP-5

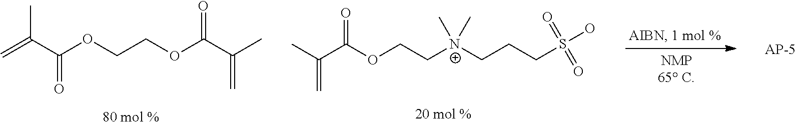 [SMILES: C=C(C)C(=O)OCCOC(=O)C(=C)C ; C=C(C)C(=O)OCC[N+](C)(C)CCCS(=O)(=O)O ; "AP-5"]

2-((methacryloyloxy)ethyl)dimethyl-(3-sulfopropyl)ammonium hydroxide (352 mg), ethylene glycol dimethacrylate (1 g), AIBN (10.3 mg), methanol (2 mL), water (3 mL), and N-methylpyrrolidinone (5 mL) were combined in a 20 mL glass vial with a screw cap. The mixture was homogenized by briefly exposing the vial to an ultrasonic bath. The slightly hazy solution was degassed by bubbling argon into the liquid through a needle for 150 seconds. After the needle was removed, the screw cap was immediately secured on the vial to make a seal. The vial was then placed in an aluminum heating block supported by a hot plate, and then the hot plate was heated to 65° C. The temperature was maintained for 15 hours, and then the resulting particulate polymer product was scraped out of the vial using a spatula and transferred into a 250 mL Erlenmeyer flask containing a magnetic stir bar and 200 mL of 1:1 methanol:water. The mixture was allowed to stir for a weekend, and then the solids were separated from the liquid by means of centrifugation at about 3000 RPM for about 5 minutes in 50 mL conical centrifuge vials. The supernatant was discarded, then the solids were re-dispersed in 200 mL of 1:1 methanol:water and stirred for 4 hours. Then, the solids were separated from the liquid by centrifugation at about 3,000 RPM for about 5 minutes. The supernatant was discarded and the pellets re-dispersed in 200 mL of 1:1 methanol:water. The mixture was stirred overnight, then the solids were separated from the liquid by centrifugation using the same conditions. After discarding the supernatant, the solids were dispersed in 200 mL of pure methanol and stirred briefly. The solids were separated from the methanol by centrifugation using the same conditions. Then, after discarding the supernatant, the solids were rinsed one final time in their centrifuge vials with pure methanol, followed by the final centrifugation in the same conditions, then discarding the methanol and drying the pellets in a vacuum oven overnight at about 65-75° C. The dried polymer product was collected and ready to be used as a solid phase extraction resin.

### Synthesis of Affinity Polymer AP-6

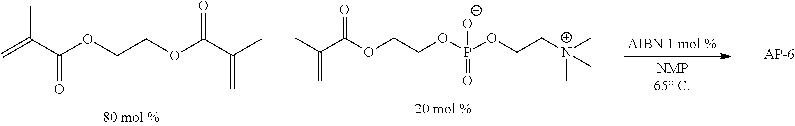

2-methacryloyloxyethylphosphorylcholine (372 mg), ethylene glycol dimethacrylate (1 g), AIBN (10.3 mg), methanol (2 mL), and N-methylpyrrolidinone (5 mL) were combined in a 20 mL glass vial with a screw cap. The mixture was homogenized by briefly exposing the vial to an ultrasonic bath. The solution was degassed by bubbling argon into the liquid through a needle for 150 seconds. After the needle was removed, the screw cap was immediately secured on the vial to make a seal. The vial was then placed in an aluminum heating block supported by a hot plate, and then the hot plate was heated to 65° C. The temperature was maintained for 15 hours, and then the resulting polymer gel was scraped out of the vial using a spatula and transferred into a 250 mL Erlenmeyer flask containing a magnetic stir bar and 200 mL of 1:1 methanol:water. The mixture was allowed to stir for a weekend, and then the solids were separated from the liquid by means of centrifugation at about 3000 RPM for about 5 minutes in 50 mL conical centrifuge vials. The supernatant was discarded, then the solids were re-dispersed in 200 mL of 1:1 methanol:water and stirred for 4 hours. Then, the solids were separated from the liquid by centrifugation at about 3,000 RPM for about 5 minutes. The supernatant was discarded and the pellets re-dispersed in 200 mL of 1:1 methanol:water. The mixture was stirred for overnight, then the solids were separated from the liquid by centrifugation using the same conditions. After discarding the supernatant, the solids were dispersed in 200 mL of pure methanol and stirred briefly. The solids were separated from the methanol by centrifugation using the same conditions. Then, after discarding the supernatant, the solids were rinsed one final time in their centrifuge vials with pure methanol, followed by the final centrifugation in the same conditions, then discarding the methanol and drying the pellets in a vacuum oven overnight at about 65-75° C. The dried polymer product was mechanically crushed, then collected and ready to be used as a solid phase extraction resin.

### Synthesis of Affinity Polymer AP-7

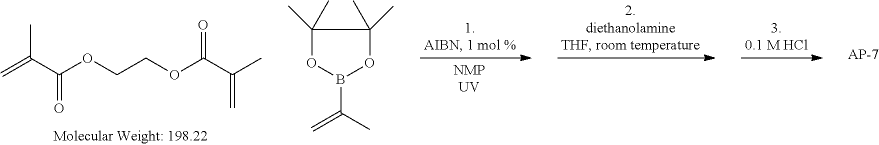

Isopropenylboronic acid pinacol ester (0.24 mL), ethylene glycol dimethacrylate (1 g), AIBN (10 mg), and N-methylpyrrolidinone (4 mL) will be combined in an 8 mL vial with a screw cap. The solution will be degassed by bubbling argon into the liquid through a needle for 2 minutes. As soon as the needle will be removed from the vial, the screw cap will be fastened to seal the vessel. The vial containing the degassed solution will be placed in between two parallel 4 W UV lamps that have emission at 365 nm. The lamps will be powered and irradiate the vial from both sides for 2 hours, at which point the obtained polymer gel will be scraped out with a spatula into a 250 mL Erlenmeyer flask containing a magnetic stir bar and 200 mL of 1:1 methanol:water. The mixture will be stirred for overnight. The solids will be removed from the liquid by means of transferring the mixture to 50 mL conical centrifuge vial and applying centrifugation at about 3000 RPM for about 5 minutes. After the centrifugation, the liquid will be discarded and the solid pellets will be dispersed in pure methanol. After allowing the solids to soak in pure methanol for overnight, the solids will be separated from the methanol by means of centrifugation. Once the supernatant methanol is discarded, the pellets will be placed in a vacuum oven at about 60° C. for about 3-6 hours until the solids are free of solvent. Once the solids are free of solvent, they will be collected and crushed in a mortar and pestle. After the crushing, the dry solids will be transferred into a dry Erlenmeyer flask. To the solids will be added 100 mL of a solution of 5% diethanolamine in anhydrous tetrahydrofuran, and the resulting mixture will be stirred at room temperature for about 4-18 hours to accomplish a conversion of the polymer-bound boronic acid pinacol ester into a polymer-bound boronic acid diethanolamine product. The solids will be separated from the liquid by transferring all of the material in to 50 mL conical centrifuge vials and applying centrifugation at about 3000 RPM for about 5 minutes. After discarding the liquid, the remaining solids will be transferred to a 250 mL Erlenmeyer flask containing 200 mL of aqueous 0.1 M HCl to accomplish hydrolysis of the polymer-bound boronic acid diethanolamine product to provide a polymer-bound free boronic acid product. After the polymer-bound boronic acid diethanolamine product is converted to the polymer-bound free boronic acid product, the solids will be separated from the liquid by means of transferring all of the material into 50 mL conical centrifuge vials and applying centrifugation at about 3000 RPM for about 5 minutes. The supernatant will be discarded and the solids will be re-dispersed in a 1:1 mixture of methanol:water and stirred for about 1-18 hours. The solids will be separated from the liquid by means of transferring all of the material into 50 mL conical centrifuge vials and applying centrifugation at about 3000 RPM for about 5 minutes. The supernatant will be discarded, and the solids will be washed for a final time with pure methanol. After stirring in pure methanol for about 1-18 hours, the solids will be separated from the methanol by means of centrifugation. After discarding the methanol supernatant, the solids will be dried out in a vacuum oven at about 60° C. for about 4-18 hours. The resulting dry polymer will be ready for use as a solid phase extraction medium.

### Synthesis of Affinity Polymer AP-8

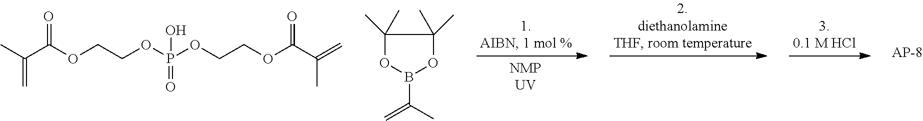

Isopropenylboronic acid pinacol ester (0.24 mL), bis(methacryloyloxyethyl)phosphate (1 g), AIBN (6.3 mg), and N-methylpyrrolidinone (4 mL) will be combined in an 8 mL vial with a screw cap. The solution will be degassed by bubbling argon into the liquid through a needle for 2 minutes. As soon as the needle will be removed from the vial, the screw cap will be fastened to seal the vessel. The vial containing the degassed solution will be placed in between two parallel 4 W UV lamps that have emission at 365 nm. The lamps will be powered and irradiate the vial from both sides for 2 hours, at which point the obtained polymer gel will be scraped out with a spatula into a 250 mL Erlenmeyer flask containing a magnetic stir bar and 200 mL of 1:1 methanol:water. The mixture will be stirred for overnight. The solids will be removed from the liquid by means of transferring the mixture to 50 mL conical centrifuge vial and applying centrifugation at about 3000 RPM for about 5 minutes. After the centrifugation, the liquid will be discarded and the solid pellets will be dispersed in pure methanol. After allowing the solids to soak in pure methanol for overnight, the solids will be separated from the methanol by means of centrifugation. Once the supernatant methanol is discarded, the pellets will be placed in a vacuum oven at about 60° C. for about 3-6 hours until the solids are free of solvent. Once the solids are free of solvent, they will be collected and crushed in a mortar and pestle. After the crushing, the dry solids will be transferred into a dry Erlenmeyer flask. To the solids will be added 100 mL of a solution of 5% diethanolamine in anhydrous tetrahydrofuran, and the resulting mixture will be stirred at room temperature for about 4-18 hours to accomplish a conversion of the polymer-bound boronic acid pinacol ester into a polymer-bound boronic acid diethanolamine product. The solids will be separated from the liquid by transferring all of the material in to 50 mL conical centrifuge vials and applying centrifugation at about 3000 RPM for about 5 minutes. After discarding the liquid, the remaining solids will be transferred to a 250 mL Erlenmeyer flask containing 200 mL of aqueous 0.1M HCl to accomplish hydrolysis of the polymer-bound boronic acid diethanolamine product to provide a polymer-bound free boronic acid product. After the polymer-bound boronic acid diethanolamine product is converted to the polymer-bound free boronic acid product, the solids will be separated from the liquid by means of transferring all of the material into 50 mL conical centrifuge vials and applying centrifugation at about 3000 RPM for about 5 minutes. The supernatant will be discarded and the solids will be re-dispersed in a 1:1 mixture of methanol:water and stirred for about 1-18 hours. The solids will be separated from the liquid by means of transferring all of the material into 50 mL conical centrifuge vials and applying centrifugation at about 3000 RPM for about 5 minutes. The supernatant will be discarded, and the solids will be washed for a final time with pure methanol. After stirring in pure methanol for about 1-18 hours, the solids will be separated from the methanol by means of centrifugation. After discarding the methanol supernatant, the solids will be dried out in a vacuum oven at about 60° C. for about 4-18 hours. The resulting dry polymer will be ready for use as a solid phase extraction medium

### Synthesis of Affinity Polymer AP-9

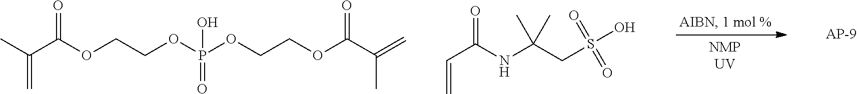 [SMILES: C=C(C)C(=O)OCCOP(=O)(O)OCCOC(=O)C(=C)C ; C=CC(=O)NC(C)(C)CS(=O)(=O)O ; "AP-9"]

2-acrylamido-2-methyl-1-propane sulfonic acid (161 mg), bis(methacryloyloxyethyl)phosphate (1 g), AIBN (6.3 mg), and N-methylpyrrolidinone (4 mL) will be combined in an 8 mL vial with a screw cap. The solution will be degassed by bubbling argon into the liquid through a needle for 2 minutes. As soon as the needle will be removed from the vial, the screw cap will be fastened to seal the vessel. The vial containing the degassed solution will be placed in between two parallel 4 W UV lamps that have emission at 365 nm. The lamps will be powered and irradiate the vial from both sides for 2 hours, at which point the obtained polymer gel will be scraped out with a spatula into a 250 mL Erlenmeyer flask containing a magnetic stir bar and 200 mL of 1:1 methanol:water. The mixture will be stirred for overnight. The solids will be removed from the liquid by means of transferring the mixture to 50 mL conical centrifuge vial and applying centrifugation at about 3000 RPM for about 5 minutes. After the centrifugation, the liquid will be discarded and the solid pellets will be dispersed in pure methanol. After allowing the solids to soak in pure methanol for overnight, the solids will be separated from the methanol by means of centrifugation. Once the supernatant methanol is discarded, the pellets will be placed in a vacuum oven at about 60° C. for about 3-6 hours until the solids are free of solvent. Once the solids are free of solvent, they will be collected and crushed in a mortar and pestle. The crushed polymer will then be transferred into a cellulose extraction thimble and loaded into the body of a soxhlet extractor. The Soxhlet extraction solvent will be a 1:1 volume mixture of water and methanol. After 24 hours of continuous Soxhlet extraction, the thimble containing the solids will be removed from the apparatus and dried in a vacuum oven at 55° C. for overnight. Once free of solvent, the dried powder will be collected and ready for use as a solid phase extraction material.

### Synthesis of Affinity Polymer AP-11

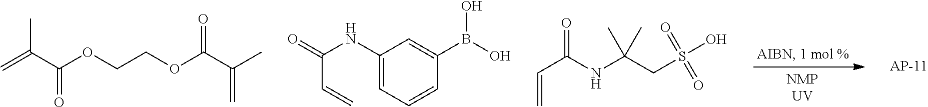

2-acrylamido-2-methyl-1-propane sulfonic acid (161 mg), 3-acrylamidophenylboronic acid (241 mg), ethylene glycol dimethacrylate (1 g), AIBN (12.4 mg), and N-methylpyrrolidinone (4 mL) will be combined in an 8 mL vial with a screw cap. The vial containing the solution will be briefly exposed to ultrasonics in an ultrasonic bath to obtain a homogeneous mixture. The solution will be degassed by bubbling argon into the liquid through a needle for 2 minutes. As soon as the needle will be removed from the vial, the screw cap will be fastened to seal the vessel. The vial containing the degassed solution will be placed in between two parallel 4 W UV lamps that have emission at 365 nm. The lamps will be powered and irradiate the vial from both sides for 2 hours, at which point the obtained polymer gel will be scraped out with a spatula into a 250 mL Erlenmeyer flask containing a magnetic stir bar and 200 mL of 1:1 methanol:water. The mixture will be stirred for overnight. The solids will be removed from the liquid by means of transferring the mixture to 50 mL conical centrifuge vial and applying centrifugation at about 3000 RPM for about 5 minutes. After the centrifugation, the liquid will be discarded and the solid pellets will be dispersed in pure methanol. After allowing the solids to soak in pure methanol for overnight, the solids will be separated from the methanol by means of centrifugation. Once the supernatant methanol is discarded, the pellets will be placed in a vacuum oven at about 60° C. for about 3-6 hours until the solids are free of solvent. Once the solids are free of solvent, they will be collected and crushed in a mortar and pestle. The crushed polymer will then be transferred into a cellulose extraction thimble and loaded into the body of a soxhlet extractor. The Soxhlet extraction solvent will be a 1:1 volume mixture of water and methanol. After 24 hours of continuous Soxhlet extraction, the thimble containing the solids will be removed from the apparatus and dried in a vacuum oven at 55° C. for overnight. Once free of solvent, the dried powder will be collected and ready for use as a solid phase extraction material.

### Synthesis of AP-13 and 14

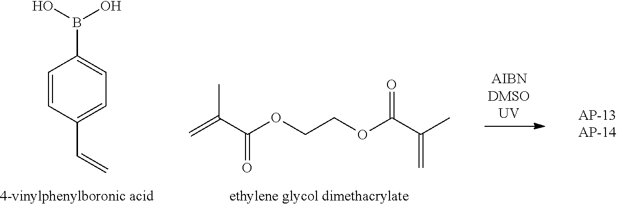

AP-13: Ethylene glycol dimethacrylate (377 mg), 4-vinylphenylboronic acid (125 mg), AIBN (4 mg), and dimethylsulfoxide (4 mL) were combined in an 8 mL glass vial with a screw cap. Once the solution was homogeneous after gentle shaking, the solution was degassed by bubbling argon gas into the liquid through a needle for 2 minutes. As soon as the argon needle was removed, the screw cap was securely fastened on the vial, and the vial containing the polymerization solution was placed in between two parallel 4 W UV lamps having light emission at 365 nm for 16 hours at room temperature. At the end of the 16 hours, the resulting polymer gel was scraped out of the vial using a spatula and transferred into an 250 mL Erlenmeyer flask containing 200 mL of a 1:1 methanol:water solution. This mixture was stirred for the duration of a weekend. The solids were then collected on a Whatman #1 filter paper in a Buchner funnel via vacuum filtration, then re-dispersed in 200 mL of 1:1 methanol:water in an Erlenmeyer flask, where it was stirred for another overnight. The solids were separated from the solution by means of transferring the mixture into 50 mL conical centrifuge vials, and then centrifugation at about 3,000 RPM for about 5 minutes. The supernatant was discarded and the pellet was washed with 1:1 methanol:water, vortexed, centrifuged again, then finally washed with pure methanol one last time prior to vortexing and final centrifugation. After the last centrifugation, the solids were dried out in a vacuum oven at about 60° C. until the solids were free of solvent. The solids were then collected and ready for use as a solid phase extraction material.

AP-14: Ethylene glycol dimethacrylate (126 mg), 4-vinylphenylboronic acid (325 mg), AIBN (4.1 mg), and dimethylsulfoxide (4 mL) were combined in an 8 mL glass vial with a screw cap. Once the solution was homogeneous after gentle shaking, the solution was degassed by bubbling argon gas into the liquid through a needle for 2 minutes. As soon as the argon needle was removed, the screw cap was securely fastened on the vial, and the vial containing the polymerization solution was placed in between two parallel 4 W UV lamps having light emission at 365 nm for 16 hours at room temperature. At the end of the 16 hours, the resulting polymer gel was scraped out of the vial using a spatula and transferred into an Erlenmeyer flask containing 200 mL of a 1:1 methanol:water solution. This mixture was stirred for the duration of a weekend. The solids were separated from the solution by means of transferring the mixture into 50 mL conical centrifuge vials, and then centrifugation at about 3,000 RPM for about 5 minutes. The supernatant was discarded and the pellet was washed with 1:1 methanol:water, vortexed, centrifuged again, then finally washed with pure methanol one last time prior to vortexing and final centrifugation. After the last centrifugation, the solids were dried out in a vacuum oven at about 60° C. until the solids were free of solvent. The solids were then collected and ready for use as a solid phase extraction material.

### Synthesis of Affinity Polymer AP-15

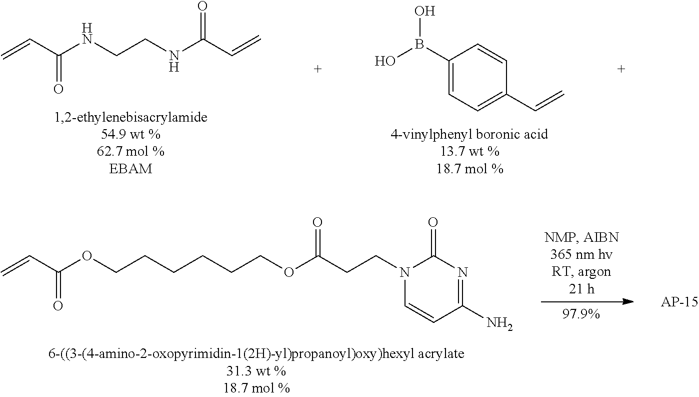 [SMILES: C=CC(=O)NCCNC(=O)C=C ; C=Cc1ccc(B(O)O)cc1 ; C=CC(=O)OCCCCCCOC(=O)CCn1ccc(N)nc1=O ; "AP-15"]

To an 8 mL glass scintillation vial equipped with a Teflon-coated magnetic stir bar was added 1,2-ethylenebisacrylamide (EBAM, 200.5 mg, 1.19×10−3 mol), 4-vinylphenyl boronic acid (4-VPBA, 49.8 mg, 3.38×10-4 mol), 6-((3-(4-amino-2-oxopyrimidin-1(2H)-yl)propanoyl)oxy)hexyl acrylate (BMEP, 114.2 mg, 3.38×10-4 mol), azobisisobutyronitrile (AIBN, 3.5 mg, 2.13×10-5 mol), and N-methyl-2-pyrrolidone (NMP, 1 mL). The reaction mixture was stirred until the solids dissolved and the solution was colorless and transparent with a slight haze. The polymerization solution was degassed with argon for 15 minutes, then capped under a stream of argon. The vial was then irradiated with UV light (λmax 365 nm) for 21 hours, during which time a transparent gel formed. The gel was crushed into a powder using a spatula, and purified through Soxhlet extraction using 1:1 methanol:deionized water for 24 hours. The solid was air dried, then dried further under high vacuum to yield a white powder, 356.9 mg, 97.9%. In a 24 hour affinity test using 10 mg polymer per 1 mL of methanolic solution containing 50 ppm guanosine, this material was observed to have removed 80% of the guanosine from solution.

### Synthesis of Affinity Polymer AP-16

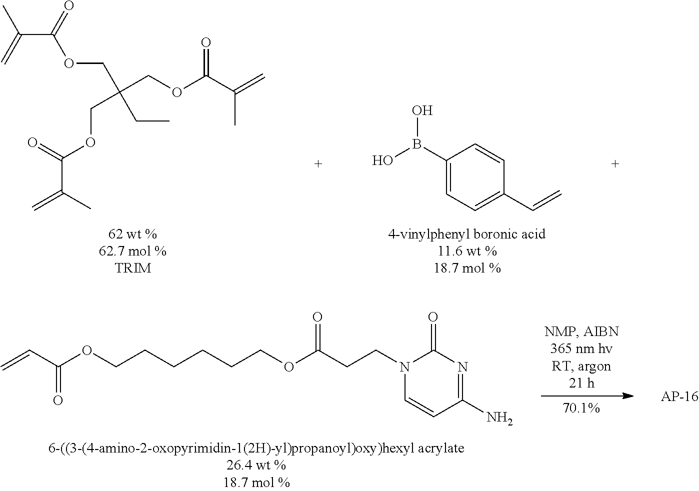 [SMILES: C=C(C)C(=O)OCC(CC)(COC(=O)C(=C)C)COC(=O)C(=C)C ; C=Cc1ccc(B(O)O)cc1 ; C=CC(=O)OCCCCCCOC(=O)CCn1ccc(N)nc1=O ; "AP-16"]

To an 8 mL glass scintillation vial equipped with a Teflon-coated magnetic stir bar was added trimethylolpropane trimethacrylate (TRIM) (0.250 mL, 7.83×10-4 mol), 4-vinylphenyl boronic acid (50.2 mg, 3.39×10-4 mol), 6-((3-(4-amino-2-oxopyrimidin-1(2H)-yl)propanoyl)oxy)hexyl acrylate (114.4 mg, 3.39×10-4 mol), azobisisobutyronitrile (3.8 mg, 2.31×10-5 mol), and n-methyl-2-pyrrolidone (1.00 mL). The reaction mixture was stirred until the solids dissolved and the solution was colorless and transparent. The polymerization solution was degassed with argon for 15 minutes, then capped under a stream of argon. The vial was then irradiated with UV light (Amax 365 nm) for 21 hours, during which time an opaque white gel formed. The polymer monolith was crushed into a powder using a spatula, and purified through Soxhlet extraction using 1:1 methanol:deionized water for 24 hours. The polymer was air dried, then dried further under high vacuum to yield a white powder, 301.0 mg, 70.1%. In a 24 hour affinity test using 10 mg polymer per 1 mL of methanolic solution containing 50 ppm guanosine, this material was observed to have removed 70% of the guanosine from solution.

### Synthesis of Affinity Polymer AP-17

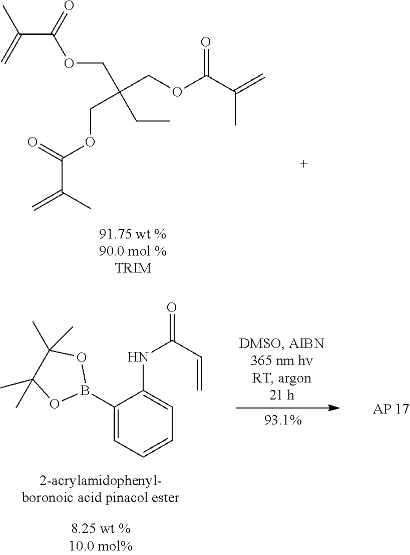

To an 8 mL glass scintillation vial equipped with a Teflon-coated magnetic stir bar was added trimethylolpropane trimethacrylate (TRIM) (1.050 mL, 3.29×10-3 mol), 2-acrylamidophenylboronic acid pinacol ester (2-AAPBE, 100.1 mg, 3.66×10-4 mol), azobisisobutyronitrile (6.1 mg, 3.72×10-5 mol), and dimethyl sulfoxide (1.00 mL). The solution was stirred until most of the solids dissolved and the solution was brown and transparent. Some colorless crystals were present on the bottom of the vial before polymerization. The polymerization solution was degassed with argon for 10 minutes, then capped under a stream of argon. The vial was then irradiated with UV light (Amax 365 nm) for 21 hours, during which time a polymer gel formed. The polymer monolith was crushed into a powder using a mortar and pestle, and purified through Soxhlet extraction using 1:1 methanol:deionized water for 21.5 hours. The solid was air dried, then oven dried at 115° C. to yield a white powder, 1.1013 g mg, 93.1% based on assumption of complete removal of the pinacol ester protecting group. In a 3.5 hour affinity test using 10 mg polymer per 1 mL of artificial beer solution containing 50 ppm guanosine, this material was observed to have removed 13% of the guanosine from solution.

### Synthesis of Affinity Polymer AP-18

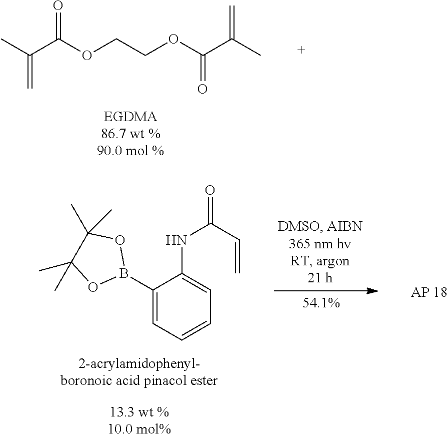

To an 8 mL glass scintillation vial equipped with a Teflon-coated magnetic stir bar was added ethylene glycol dimethacrylate (EGDMA) (0.620 mL, 3.28×10-3 mol), 2-acrylamidophenylboronic acid pinacol ester (2-AAPBE, 99.8 mg, 3.65×10-4 mol), azobisisobutyronitrile (6.1 mg, 3.72×10-5 mol), and dimethyl sulfoxide (1.00 mL). The solution was stirred until most of the solids dissolved and the solution was brown and transparent. Some colorless crystals were present on the bottom of the vial before polymerization. The polymerization solution was degassed with argon for 10 minutes, then capped under a stream of argon. The vial was then irradiated with UV light (λmax 365 nm) for 21 hours, during which time a polymer gel formed. The polymer monolith was crushed into a powder using a mortar and pestle, and purified through Soxhlet extraction using 1:1 methanol:deionized water for 21.5 hours. The solid was air dried, then oven dried at 115° C. to yield a white powder, 0.39 g, 51.9% based on assumption of complete removal of pinacol ester protecting group. In a 3.5 hour affinity test using 10 mg polymer per 1 mL of artificial beer solution containing 50 ppm guanosine, this material was observed to have removed 35% of the guanosine from solution.

### Synthesis of Additional Examples of Affinity Polymers

Additional affinity polymer composites were prepared in accordance with the procedures above, using thermal or UV irradiation conditions for polymerization. These compounds may be synthesized, refined, and purified using the methods above.

Table 2 shows affinity polymers prepared in accordance with the procedures of the examples above.

TABLE 2
Affinity polymer composites.

| Monomer 1 | Monomer 2 | Monomer 3 | Monomer 4 | Monomer 5 | | |
|---|---|---|---|---|---|---|
| mmol or | mmol or | mmol or | mmol or | mmol or | | Affinity |
| mol % | mol % | mol % | mol % | mol % | Conditions | Polymer |
| BMEP | — | — | — | — | AIBN (5.1 mg), NMP (5 mL), | AP-1A |
| 3.1 mmol | | | | | 65° C., 2 h | |
| BMEP | — | — | — | — | AIBN (5.1 mg), NMP (5 mL), | AP-1B |
| 3.1 mmol | | | | | 65° C., 15 h | |
| BMEP | — | — | — | — | AIBN (10.2 mg), NMP (5 mL), | AP-1C |
| 3.1 mmol | | | | | 65° C., 15 h | |
| BMEP | — | — | — | — | ABCN (127 mg), DMF (9.1 mL), | AP-1D |
| 56.8 mmol | | | | | UV, 25 min | |
| BMEP | 3-APBA | — | — | — | AIBN (6.1 mg), NMP (5 mL), | AP-2 |
| 3.1 mmol | 0.65 mmol | | | | 65° C., 2 h | |
| BMEP | EGDMA | — | — | — | AIBN (10 mg), NMP (5 mL), | AP-3 |
| 1.06 mmol | 5 mmol | | | | 65° C., 2 h | |
| EGDMA | AMPSA | — | — | — | AIBN (10.3 mg), NMP (5 mL), | AP-4 |
| 5 mmol | 1.26 mmol | | | | 65° C., 15 h | |
| EGDMA | DMAPS | — | — | — | AIBN (10.3 mg), MeOH (2 mL)/ | AP-5 |
| 5 mmol | 1.26 mmol | | | | H₂O (3 mL)/NMP (5 mL), | |
| | | | | | 65° C., 15 h | |
| EGDMA | MPC | — | — | — | AIBN (10.3 mg), MeOH (2 mL)/ | AP-6 |
| 5 mmol | 1.26 mmol | | | | NMP (5 mL), 65° C., | |
| | | | | | 15 h | |
| EGDMA | IPBPE | — | — | — | (1) AIBN (10 mg), NMP (4 mL), | AP-7 |
| 5 mmol | 1.28 mmol | | | | UV 365 nm, 2 h; | |
| | | | | | (2) 0.1N HCl | |
| BMEP | IPBPE | — | — | — | (1) AIBN (10 mg), NMP (4 mL), | AP-8 |
| 3.1 mmol | 1.28 mmol | | | | UV 365 nm, 2 h; | |
| | | | | | (2) 0.1N HCl | |
| BMEP | AMPSA | — | — | — | AIBN (6.3 mg), NMP (4 mL), | AP-9 |
| 3.1 mmol | 0.78 mmol | | | | UV 365 nm, 2 h | |
| EGDMA | AMPSA | 3-APBA | — | — | AIBN (12.4 mg), NMP (4 mL), | AP-11 |
| 5 mmol | 0.78 mmol | 1.26 mmol | | | UV 365 nm, 2 h | |
| 4-VPBA | EGDMA | — | — | — | AIBN (4 mg), DMSO (4 mL), | AP-13 |
| 0.84 mmol | 1.9 mmol | | | | UV 365 nm, 16 h | |
| 4-VPBA | EGDMA | — | — | — | AIBN (4.1 mg), DMSO (4 mL), | AP-14 |
| 2.2 mmol | 0.64 mmol | | | | UV 365 nm, 16 h | |
| EBAM | 4-VPBA | C1POHA | — | — | AIBN (3.5 mg), NMP (1 mL), | AP-15 |
| 1.2 mmol | 0.34 mmol | 0.34 mmol | | | UV 365 nm, 21 h | |
| TRIM | 4-VPBA | C1POHA | — | — | AIBN (3.8 mg), NMP (1 mL), | AP-16 |
| 0.79 mmol | 0.34 mmol | 0.34 mmol | | | UV 365 nm, 21 h | |
| TRIM | 2-AAPBE | — | — | — | AIBN (6.1 mg), DMSO (1 mL), | AP-17 |
| 3.3 mmol | 0.37 mmol | | | | UV 365 nm, 21 h | |
| EGDMA | 2-AAPBE | — | — | — | AIBN (6.1 mg), DMSO (1 mL), | AP-18 |
| 3.3 mmol | 0.37 mmol | | | | UV 365 nm, 21 h | |
| MBAM | AMPSA | 3-APBA | — | — | AIBN (1 mol %), NMP, | AP-19 |
| 60% | 20% | 20% | | | UV 365 nm, 18 h | |
| MBAM | AMPSA | 3-APBA | — | — | AIBN (1 mol %), NMP, | AP-20 |
| 60% | 20% | 20% | | | UV 365 nm, 18 h | |
| MBAM | AMPSA | 3-APBA | — | — | AIBN (1 mol %), NMP, | AP-21 |
| 60% | 20% | 20% | | | UV 365 nm, 18 h | |
| MBAM | AMPSA | 3-APBA | — | — | AIBN (1 mol %), NMP, | AP-22³ |
| 60% | 20% | 20% | | | UV 365 nm, 18 h | |
| MBAM | AMPSA | 3-APBA | — | — | AIBN (1 mol %), NMP, | AP-23⁴ |
| 60% | 20% | 20% | | | UV 365 nm, 18 h | |
| MBAM | AMPSA | 3-APBA | — | — | AIBN (1 mol %), NMP, | AP-24 |
| 60% | 25% | 15% | | | UV 365 nm, 18 h | |
| MBAM | AMPSA | 3-APBA | | | AIBN (1 mol %), NMP, | AP-25¹ |
| 60% | 25% | 15% | | | UV 365 nm, 18 h | |
| MBAM | AMPSA | 3-APBA | | | AIBN (1 mol %), NMP, | AP-26² |
| 60% | 25% | 15% | | | UV 365 nm, 18 h | |
| MBAM | AMPSA | 3-APBA | — | — | AIBN (1 mol %), NMP, | AP-27 |
| 60% | 30% | 10% | | | UV 365 nm, 18 h | |
| MBAM | AMPSA | 3-APBA | — | — | AIBN (1 mol %), NMP, | AP-28 |
| 60% | 35% | 5% | | | UV 365 nm, 18 h | |
| DVB | AMPSA | 3-APBA | — | — | AIBN (1 mol %), NMP, | AP-29 |
| 60% | 20% | 20% | | | UV 365 nm, 18 h | |
| EGDMA | AMPSA | 3-APBA | — | — | AIBN (1 mol %), NMP, | AP-30 |
| 60% | 20% | 20% | | | UV 365 nm, 18 h | |
| EGDMA | AMPSA | 3-APBA | — | — | AIBN (1 mol %), NMP, | AP-31 |
| 60% | 25% | 15% | | | UV 365 nm, 18 h | |
| EGDMA | HEMA | 3-APBA | — | — | AIBN (1 mol %), NMP, | AP-32 |
| 60% | 25% | 15% | | | UV 365 nm, 18 h | |
| EGDMA | HEMA | AMPSA | — | — | AIBN (1 mol %), NMP, | AP-33 |
| 60% | 20% | 20% | | | UV 365 nm, 18 h | |
| MBAM | DMAPMA | AMPSA | 3-APBA | — | AIBN (1 mol %), NMP, | AP-34 |
| 40% | 20% | 25% | 15% | | UV 365 nm, 18 h | |
| MBAM | DMAPAA | AMPSA | 3-APBA | — | AIBN (1 mol %), NMP, | AP-35 |
| 40% | 20% | 25% | 15% | | UV 365 nm, 18 h | |
| MBAM | DMAEMA | AMPSA | 3-APBA | — | AIBN (1 mol %), NMP, | AP-36 |
| 40% | 20% | 25% | 15% | | UV 365 nm, 18 h | |
| EBA | AMPSA | 3-APBA | — | — | AIBN (1 mol %), NMP, | AP-37 |
| 60% | 25% | 15% | | | UV 365 nm, 18 h | |
| MBAM | AMPSA | 3-MAPBA | — | — | AIBN (1 mol %), NMP, | AP-38 |
| 60% | 25% | 15% | | | UV 365 nm, 18 h | |
| MBMA | AMPSA | 3-APBA | — | — | AIBN (1 mol %), NMP, | AP-39 |
| 60% | 25% | 15% | | | UV 365 nm, 18 h | |
| BMEAS | AMPSA | 3-APBA | — | — | AIBN (1 mol %), NMP, | AP-40 |
| 60% | 25% | 15% | | | UV 365 nm, 18 h | |
| MBAM | DMAPS | AMPSA | 3-APBA | — | AIBN (1 mol %), NMP, | AP-41 |
| 50% | 10% | 25% | 15% | | UV 365 nm, 18 h | |
| MBAM | MPC | AMPSA | 3-APBA | — | AIBN (1 mol %), NMP, | AP-42 |
| 50% | 10% | 25% | 15% | | UV 365 nm, 18 h | |
| MBAM | VSA | 3-APBA | — | — | AIBN (1 mol %), NMP, | AP-43 |
| 60% | 25% | 15% | | | UV 365 nm, 18 h | |
| MBAM | VSA | 3-APBA | — | — | AIBN (1 mol %), NMP, | AP-44² |
| 60% | 25% | 15% | | | UV 365 nm, 18 h | |
| MBAM | VSA | 3-APBA | — | — | AIBN (1 mol %), NMP, | AP-45³ |
| 60% | 25% | 15% | | | UV 365 nm, 18 h | |
| MBAM | VSA | 3-APBA | — | — | AIBN (1 mol %), NMP, | AP-46⁴ |
| 60% | 25% | 15% | | | UV 365 nm, 18 h | |
| MBAM | 4-VPSAS | 3-APBA | — | — | (1) AIBN (1 mol %), NMP, | AP-47 |
| 60% | 25% | 15% | | | UV 365 nm, 18 h; (2) 1N | |
| | | | | | HCl | |
| MBAM | 4-VPSAS | 3-APBA | — | — | (1) AIBN (1 mol %), NMP, | AP-48² |
| 60% | 25% | 15% | | | UV 365 nm, 18 h; (2) 1N | |
| | | | | | HCl | |
| MBAM | BMEP | VSA | 4-VPSAS | 3-APBA | (1) AIBN (1 mol %), NMP, | AP-49 |
| 15% | 15% | 25% | 25% | 20% | UV 365 nm, 18 h; (2) 1N | |
| | | | | | HCl | |
| MBAM | BMEP | VSA | 4-VPSAS | 3-APBA | (1) AIBN (1 mol %), NMP, | AP-50 |
| 15% | 15% | 20% | 35% | 15% | UV 365 nm, 18 h; (2) 1N | |
| | | | | | HCl | |
| MBAM | BMEP | VSA | 4-VPSAS | 3-APBA | (1) AIBN (1 mol %), NMP, | AP-51² |
| 15% | 15% | 20% | 35% | 15% | UV 365 nm, 18 h; (2) 1N | |
| | | | | | HCl | |
| MBAM | AMPSA | 4-VPSAS | 3-APBA | — | (1) AIBN (1 mol %), NMP, | AP-52 |
| 30% | 20% | 35% | 15% | | UV 365 nm, 18 h; (2) 1N | |
| | | | | | HCl | |
| MBAM | AMPSA | 4-VPSAS | 3-APBA | — | (1) AIBN (1 mol %), NMP, | AP-53 |
| 35% | 25% | 25% | 15% | | UV 365 nm, 18 h; (2) 1N | |
| | | | | | HCl | |
| MBAM | AMPSA | 4-VPSAS | 3-APBA | — | (1) AIBN (1 mol %), NMP, | AP-54² |
| 35% | 25% | 25% | 15% | | UV 365 nm, 18 h; (2) 1N | |
| | | | | | HCl | |
| MBAM | AMPSA | 4-VPSAS | 3-APBA | — | (1) AIBN (1 mol %), NMP, | AP-55 |
| 30% | 25% | 30% | 15% | | UV 365 nm, 18 h; (2) 1N | |
| | | | | | HCl | |
| MBAM | AMPSA | 4-VPSAS | 3-APBA | — | (1) AIBN (1 mol %), NMP, | AP-56 |
| 30% | 30% | 25% | 15% | | UV 365 nm, 18 h; (2) 1N | |
| | | | | | HCl | |
| MBAM | AMPSA | 4-VPSAS | 3-APBA | — | (1) AIBN (1 mol %), NMP, | AP-57 |
| 30% | 35% | 20% | 15% | | UV 365 nm, 18 h; (2) 1N | |
| | | | | | HCl | |
| MBAM | BMEP | AMPSA | 4-VPSAS | 3-APBA | (1) AIBN (1 mol %), NMP, | AP-58 |
| 15% | 15% | 20% | 35% | 15% | UV 365 nm, 18 h; (2) 1N | |
| | | | | | HCl | |
| MBAM | VSA | 4-VPSAS | 3-APBA | — | (1) AIBN (1 mol %), NMP, | AP-59 |
| 30% | 20% | 35% | 15% | | UV 365 nm, 18 h; (2) 1N | |
| | | | | | HCl | |
| MBAM | VSA | 4-VPSAS | 3-APBA | — | (1) AIBN (1 mol %), NMP, | AP-60 |
| 30% | 30% | 25% | 15% | | UV 365 nm, 18 h; (2) 1N | |
| | | | | | HCl | |
| MBAM | VSA | 4-VPSAS | 3-APBA | — | (1) AIBN (1 mol %), NMP, | AP-61 |
| 35% | 25% | 25% | 15% | | UV 365 nm, 18 h; (2) 1N | |
| | | | | | HCl | |
| MBAM | VSA | 4-VPSAS | 3-APBA | — | (1) AIBN (1 mol %), NMP, | AP-62 |
| 30% | 35% | 20% | 15% | | UV 365 nm, 18 h; (2) 1N | |
| | | | | | HCl | |
| MBAM | VSA | 4-VPSAS | 3-APBA | — | (1) AIBN (1 mol %), NMP, | AP-63 |
| 30% | 25% | 30% | 15% | | UV 365 nm, 18 h; (2) 1N | |
| | | | | | HCl | |
| MBAM | VSA | 4-VPSAS | 3-APBA | — | (1) AIBN (1 mol %), NMP, | AP-64² |
| 30% | 20% | 35% | 15% | | UV 365 nm, 18 h; (2) 1N | |
| | | | | | HCl | |
| MBAM | VSA | AMPSA | 3-APBA | — | AIBN (1 mol %), NMP, | AP-65 |
| 30% | 20% | 35% | 15% | | UV 365 nm, 18 h | |
| MBAM | SEMA | 3-APBA | — | — | (1) AIBN (1 mol %), NMP, | AP-66 |
| 60% | 25% | 15% | | | UV 365 nm, 18 h; (2) 1N | |
| | | | | | HCl | |
| MBAM | SEMA | 4-VPSAS | 3-APBA | — | (1) AIBN (1 mol %), NMP, | AP-67 |
| 35% | 25% | 25% | 15% | | UV 365 nm, 18 h; (2) 1N | |
| | | | | | HCl | |
| MBAM | SEMA | 4-VPSAS | 3-APBA | — | (1) AIBN (1 mol %), NMP, | AP-68 |
| 30% | 20% | 35% | 15% | | UV 365 nm, 18 h; (2) 1N | |
| | | | | | HCl | |
| MBAM | SEMA | 4-VPSAS | 3-APBA | — | (1) AIBN (1 mol %), NMP, | AP-69 |
| 30% | 25% | 30% | 15% | | UV 365 nm, 18 h; (2) 1N | |
| | | | | | HCl | |
| MBAM | SEMA | 4-VPSAS | 3-APBA | — | (1) AIBN (1 mol %), NMP, | AP-70 |
| 30% | 30% | 25% | 15% | | UV 365 nm, 18 h; (2) 1N | |
| | | | | | HCl | |
| MBAM | SEMA | 4-VPSAS | 3-APBA | — | (1) AIBN (1 mol %), NMP, | AP-71 |
| 30% | 35% | 20% | 15% | | UV 365 nm, 18 h; (2) 1N | |
| | | | | | HCl | |
| MBAM | SPM | 3-APBA | — | — | (1) AIBN (1 mol %), NMP, | AP-72 |
| 60% | 25% | 15% | | | UV 365 nm, 18 h; (2) 1N | |
| | | | | | HCl | |
| MBAM | SPM | 4-VPSAS | 3-APBA | — | (1) AIBN (1 mol %), NMP, | AP-73 |
| 35% | 25% | 25% | 15% | | UV 365 nm, 18 h; (2) 1N | |
| | | | | | HCl | |
| MBAM | SPM | 4-VPSAS | 3-APBA | — | (1) AIBN (1 mol %), NMP, | AP-74 |
| 30% | 20% | 35% | 15% | | UV 365 nm, 18 h; (2) 1N | |
| | | | | | HCl | |
| MBAM | SPM | 4-VPSAS | 3-APBA | — | (1) AIBN (1 mol %), NMP, | AP-75 |
| 30% | 25% | 30% | 15% | | UV 365 nm, 18 h; (2) 1N | |
| | | | | | HCl | |
| MBAM | SPA | 4-VPSAS | 3-APBA | — | (1) AIBN (1 mol %), | AP-76 |
| 30% | 20% | 35% | 15% | | NMP, UV 365 nm, 18 h; (2) | |
| | | | | | Amberlite IR 120 | |
| MBAM | SAS | 3-APBA | — | — | (1) AIBN (1 mol %), NMP, | AP-77 |
| 60% | 25% | 15% | | | UV 365 nm, 18 h; (2) 1N | |
| | | | | | HCl | |
| MBAM | SAS | 4-VPSAS | 3-APBA | — | (1) AIBN (1 mol %), | AP-78 |
| 35% | 25% | 55% | 15% | | NMP, UV 365 nm, 18 h; (2) | |
| | | | | | Amberlite IR 120 | |
| MBAM | SMAS | 4-VPSAS | 3-APBA | — | (1) AIBN (1 mol %), | AP-79 |
| 30% | 20% | 35% | 15% | | NMP, UV 365 nm, 18 h; (2) | |
| | | | | | Amberlite IR 120 | |
| MBAM | AA | 4-VPSAS | 3-APBA | — | (1) AIBN (1 mol %), | AP-80 |
| 30% | 20% | 35% | 15% | | NMP, UV 365 nm, 18 h; (2) | |
| | | | | | Amberlite IR 120 | |
| MBAM | VAA | 4-VPSAS | 3-APBA | — | (1) AIBN (1 mol %), | AP-81 |
| 30% | 20% | 35% | 15% | | NMP, UV 365 nm, 18 h; (2) | |
| | | | | | Amberlite IR 120 | |
| MBAM | AAA | 4-VPSAS | 3-APBA | — | (1) AIBN (1 mol %), NMP, | AP-82 |
| 30% | 20% | 35% | 15% | | UV 365 nm, 18 h; (2) 4N | |
| | | | | | HCl | |
| MBAM | VSA | AMPSA | 4-VPSAS | 3-APBA | (1) AIBN (1 mol %), NMP, | AP-83 |
| 30% | 20% | 15% | 20% | 15% | UV 365 nm, 18 h; (2) 1N | |
| | | | | | HCl | |
| MBAM | VSA | AMPSA | 4-VPSAS | 3-APBA | (1) AIBN (1 mol %), NMP, | AP-84 |
| 25% | 20% | 20% | 20% | 15% | UV 365 nm, 18 h; (2) 1N | |
| | | | | | HCl | |
| MBAM | VSA | AMPSA | 4-VPSAS | 3-APBA | (1) AIBN (1 mol %), NMP, | AP-85 |
| 20% | 25% | 15% | 25% | 15% | UV 365 nm, 18 h; (2) 1N | |
| | | | | | HCl | |
| MBAM | VSA | AMPSA | 4-VPSAS | 3-APBA | (1) AlBN (1 mol %), NMP, | AP-86 |
| 15% | 25% | 20% | 25% | 15% | UV 365 nm, 18 h; (2) 1N | |
| | | | | | HCl | |
| MBAM | VSA | AMPSA | 4-VPSAS | 3-APBA | (1) AlBN (1 mol %), NMP, | AP-87 |
| 30% | 10% | 30% | 15% | 15% | UV 365 nm, 18 h; (2) 1N | |
| | | | | | HCl | |
| MBAM | VSA | AMPSA | 4-VPSAS | 3-APBA | (1) AlBN (1 mol %), NMP, | AP-88 |
| 30% | 15% | 25% | 15% | 15% | UV 365 nm, 18 h; (2) 1N | |
| | | | | | HCl | |
| MBAM | VSA | AMPSA | 4-VPSAS | 3-APBA | (1) AlBN (1 mol %), NMP, | AP-89 |
| 30% | 20% | 20% | 15% | 15% | UV 365 nm, 18 h; (2) 1N | |
| | | | | | HCl | |
| MBAM | VSA | 4-VPSAS | 3-ABS | — | (1) AlBN (1 mol %), NMP, | AP-90 |
| 30% | 20% | 35% | 15% | | UV 365 nm, 18 h; (2) 4N | |
| | | | | | HCl | |
| MBAM | VSA | 4-VPSAS | 4-ABS | — | (1) AlBN (1 mol %), NMP, | AP-91 |
| 30% | 20% | 35% | 15% | | UV 365 nm, 18 h; (2) 1N | |
| | | | | | HCl | |
| MBAM | VSA | 3-ABS | 3-APBA | — | (1) AlBN (1 mol %), NMP, | AP-92 |
| 30% | 20% | 35% | 15% | | UV 365 nm, 18 h; (2) 4N | |
| | | | | | HCl | |
| MBAM | VSA | 4-ABS | 3-APBA | — | (1) AlBN (1 mol %), NMP, | AP-93 |
| 30% | 20% | 35% | 15% | | UV 365 nm, 18 h; (2) 1N | |
| | | | | | HCl | |
| MBAM | AMPSA | 3-APBA | — | — | AlBN (1 mol %), | AP-94 |
| 60% | 20% | 20% | | | MeOH:NMP (1:1), 65° C., | |
| | | | | | 105 min | |
| PBPone | AMPSA | 3-APBA | — | — | AlBN (1 mol %), | AP-95 |
| 60% | 20% | 20% | | | MeOH:NMP (1:1), 65° C., | |
| | | | | | 105 min | |
| DHEBAM | AMPSA | 3-APBA | — | — | AlBN (1 mol %), | AP-96 |
| 60% | 20% | 20% | | | MeOH:NMP (1:1), 65° C., | |
| | | | | | 105 min | |
| MBAM | AMPSA | 3-APBA | — | — | AlBN (1 mol %), NMP, | AP-97 |
| 60% | 20% | 20% | | | 65° C., 105 min | |
| PBPone | AMPSA | 3-APBA | — | — | AlBN (1 mol %), NMP, | AP-98 |
| 60% | 20% | 20% | | | 65° C., 105 min | |
| DHEBAM | AMPSA | 3-APBA | — | — | AlBN (1 mol %), NMP, | AP-99 |
| 60% | 20% | 20% | | | 65° C., 105 min | |
| MBAM | AMPSA | 3-APBA | — | — | AlBN (1 mol %), DMSO, | AP-100 |
| 60% | 20% | 20% | | | 65° C., 2 h | |
| DHEBAM | AMPSA | 3-APBA | — | — | AlBN (1 mol %), DMSO, | AP-101 |
| 60% | 20% | 20% | | | 65° C., 2 h | |
| MBAM | 3-APBA | — | — | — | AlBN (1 mol %), | AP-102 |
| 60% | 40% | | | | MeOH:NMP (1:1), 65° C., 2 h | |
| MBAM | AMPSA | — | — | — | AlBN (1 mol %), | AP-103 |
| 60% | 40% | | | | MeOH:NMP (1:1), 65° C., 2 h | |
| MBAM | AMPSA | 3-APBA | BMEP | — | DMSO (3 mass eq.), AlBN, | AP-104 |
| 40% | 20% | 20% | 20% | | 65° C., 2 h | |
| MBAM | 3-APBA | BMEP | — | — | DMSO (3 mass eq.), AlBN, | AP-105 |
| 60% | 20% | 20% | | | 65° C., 2 h | |
| MBAM | AMPSA | BMEP | — | — | DMSO (3 mass eq.), AlBN, | AP-106 |
| 60% | 20% | 20% | | | 65° C., 2 h | |
| MBAM | 4-VPBA | — | — | — | DMSO (3 mass eq.), AlBN, | AP-107 |
| 60% | 40% | | | | 65° C., 2 h | |
| MBAM | AMPSA | 4-VPBA | — | — | DMSO (5 mass eq.), AlBN, | AP-108 |
| 60% | 20% | 20% | | | 65° C., 160 min | |
| MBAM | AMPSA | 4-VPBA | BMEP | — | DMSO (4 mass eq.), AlBN, | AP-109 |
| 40% | 20% | 20% | 20% | | 65° C., 160 min | |
| BMEP | 4-VPBA | — | — | — | DMSO (3 mass eq.), AlBN, | AP-110 |
| 80% | 20% | | | | 65° C., 160 min | |
| BMEP | 4-VPBA | AMPSA | — | — | DMSO (3 mass eq.), AlBN, | AP-111 |
| 60% | 20% | 40% | | | 65° C., 160 min | |
| MBAM | AMPSA | BMEP | — | — | DMSO (3 mass eq.), AlBN, | AP-112 |
| 20% | 40% | 40% | | | 65° C., 160 min | |
| MBAM | AMPSA | BMEP | — | — | DMSO (3 mass eq.), AlBN, | AP-113 |
| 40% | 40% | 20% | | | 65° C., 2 h | |
| BMEP | 3-APBA | — | — | — | AlBN, DMSO | AP-114 |
| 80% | 20% | | | | | |
| BMEP | NPA | — | — | — | AlBN, DMSO | AP-115 |
| 80% | 20% | | | | | |
| MBAM | NPA | AMPSA | — | — | AlBN, DMSO | AP-116 |
| 60% | 20% | 20% | | | | |
| DHEBAM | MBAM | AMPSA | 3-APBA | — | AlBN, DMSO | AP-117 |
| 10% | 50% | 20% | 20% | | | |
| BMEP | NPA | — | — | — | AlBN, DMSO | AP-118 |
| 50% | 50% | | | | | |
| BMEP | NPA | — | — | — | AlBN, DMSO | AP-119 |
| 20% | 80% | | | | | |
| BMEP | 3-APBA | AMPSA | — | — | AlBN, DMSO (5.5 g), | AP-120² |
| 60% | 20% | 20% | | | 65° C., 2 h | |
| BMEP | 3-APBA | AMPSA | — | — | ABCVA, DMSO (5.5 g), | AP-121² |
| 60% | 20% | 20% | | | hexane (40 mL), SPAN85/ | |
| | | | | | SPAN80 (1 mL), 65° C., 2 h | |
| MBAM | 3-APBA | AMPSA | PEG(550)- | — | AlBN, DMSO (2.5 mL), | AP-122 |
| 40% | 15% | 25% | DMA | | 65° C., 2 h | |
| | | | 20% | | | |
| MBAM | 3-APBA | AMPSA | PEG(550)- | — | AlBN, DMSO (3.3 mL), | AP-123 |
| 20% | 15% | 25% | DMA | | 65° C., 2 h | |
| | | | 40% | | | |
| 3-APBA | AMPSA | PEG(550)DMA | — | — | AlBN, DMSO (4.1 mL), | AP-124 |
| 15% | 25% | 60% | | | 65° C., 2 h | |
| BMEP | 3-APBA | AMPSA | PEG300-MA | — | AlBN, DMSO (5.5 g), | AP-125² |
| 55% | 18% | 18% | 9% | | 65° C., 2 h | |
| BMEP | 3-APBA | AMPSA | PEG300-MA | — | AlBN, DMSO (5.5 g), | AP-126² |
| 46% | 15% | 15% | 23% | | 65° C., 2 h | |
| MBAM | 3-APBA | AMPSA | AA | BMEP | AlBN, DMSO (2.92 mL), | AP-127 |
| 20% | 15% | 25% | 10% | 30% | 65° C., 2 h | |
| MBAM | 3-APBA | AMPSA | AA | BMEP | AlBN, DMSO (2.92 mL), | AP-128² |
| 20% | 15% | 25% | 10% | 30% | 65° C., 2 h | |
| AA | MBAM | 3-APBA | AMPSA | BMEP | AlBN (1 mol %), DMSO | AP-129 |
| 15% | 40% | 15% | 15% | 15% | (3.53 mL), 65° C., 2 h | |
| AA | MBAM | 3-APBA | AMPSA | BMEP | AlBN (1 mol %), DMSO | AP-130 |
| 35% | 16.3% | 16.3% | 16.3% | 16.3% | (3.18 mL), 65° C., 2 h | |
| AA | MBAM | 3-APBA | AMPSA | BMEP | AlBN (1 mol %), DMSO | AP-131 |
| 20% | 40% | 15% | 15% | 15% | (3.18 mL), 65° C., 2 h | |
| AA | MBAM | 3-APBA | AMPSA | BMEP | AlBN (1 mol %), DMSO | AP-132 |
| 30% | 40% | 15% | 15% | 15% | (3.18 mL), 65° C., 2 h | |
| AA | MBAM | 3-APBA | AMPSA | BMEP | AlBN (1 mol %), DMSO | AP-133 |
| 40% | 40% | 15% | 15% | 15% | (2.82 mL), 65° C., 2 h | |
| VSA | AA | MBAM | 3-APBA | BMEP | AlBN (1 mol %), DMSO | AP-134² |
| 35% | 35% | 10% | 10% | 10% | (2.12 mL, 2 mol eq.), | |
| | | | | | 65° C., 2 h | |
| VSA | AA | MBAM | 3-APBA | BMEP | AlBN (1 mol %), DMSO | AP-135 |
| 35% | 35% | 10% | 10% | 10% | (2.12 mL, 2 mol eq.), | |
| | | | | | 65° C., 2 h | |
| AA | MBAM | 3-APBA | AMPSA | BMEP | AlBN (1 mol %), DMSO (3.2 mL, | AP-136² |
| 35% | 16.3% | 16.3% | 16.3% | 16.3% | 3 mol eq.), 65° C., 2 h | |
| AA | 3-APBA | DVS | AMPSA | NVP | AlBN (1 mol %), DMSO | AP-137 |
| 15% | 30% | 10% | 30% | 15% | (2.12 mL, 2 mol eq.), 65° C. | |
| AA | 3-APBA | DVS | AMPSA | BMEP | AlBN (1 mol %), DMSO | AP-138⁵ |
| 15% | 15% | 5% | 20% | 25% | (2.12 mL, 2 mol eq.), 65° C. | |
| AA | 3-APBA | DVS | AMPSA | NVP | AlBN (1 mol %), DMSO | AP-139 |
| 25% | 25% | 10% | 25% | 15% | (2.12 mL, 2 mol eq.), 65° C. | |
| AA | 3-APBA | VSA | DVS | — | AlBN (1 mol %), DMSO | AP-140 |
| 25% | 25% | 25% | 25% | | (2.12 mL, 2 mol eq.), 65° C. | |
| AA | MBAM | 3-APBA | VSA | DVS | AlBN (1 mol %), DMSO | AP-141⁶ |
| 12.5% | 12.5% | 12.5% | 12.5% | 12.5% | (2.12 mL, 2 mol eq.), 65° C. | |
| MBAM | 3-APBA | 4-VPSAS | 4-VBA | — | AlBN (1 mol %), DMSO | AP-142 |
| 19% | 27% | 27% | 27% | | (300 mol %), 65° C., 2 h | |
| MBAM | 3-APBA | 4-VPSAS | 4-VBA | — | AlBN (1 mol %), DMSO | AP-143 |
| 28% | 24% | 24% | 24% | | (300 mol %), 65° C., 2 h | |
| MBAM | 3-APBA | 4-VPSAS | 4-VBA | — | AlBN (1 mol %), DMSO | AP-144 |
| 39% | 21% | 21% | 21% | | (350 mol %), 65° C., 2 h | |
| MBAM | 3-APBA | 4-VBA | AMPSA | — | AlBN (1 mol %), DMSO | AP-145 |
| 19% | 27% | 25% | 27% | | (300 mol %), 65° C., 2 h | |
| MBAM | 3-APBA | 4-VPSAS | AA | — | AlBN (1 mol %), DMSO | AP-146 |
| 19% | 27% | 27% | 27% | | (300 mol %), 65° C., 2 h | |
| MBAM | 3-APBA | AA | AMPSA | — | AlBN (1 mol %), DMSO | AP-147 |
| 19% | 27% | 27% | 27% | | (300 mol %), 65° C., 2 h | |
| MBAM | 3-APBA | AA | AMPSA | — | AlBN (0.4 mol %), DMSO | AP-148 |
| 19% | 27% | 27% | 27% | | (300 mol %), 65° C., 2 h | |
| MBAM | 3-APBA | AA | AMPSA | — | AlBN (0.4 mol %), DMSO | AP-149² |
| 19% | 27% | 27% | 27% | | (300 mol %), 65° C., 2 h | |
| MBAM | 3-APBA | AA | 4-VPSAS | — | AlBN (1 mol %), DMSO | AP-150² |
| 19% | 27% | 27% | 27% | | (300 mol %), 65° C., 2 h | |
| MBAM | 3-APBA | AA | AMPSA | — | AlBN (0.6 mol %), DMSO | AP-151 |
| 19% | 27% | 27% | 27% | | (250 mol %), 65° C., 2 h | |
| MBAM | 3-APBA | AA | AMPSA | — | AlBN (0.6 mol %), DMSO | AP-152² |
| 19% | 27% | 27% | 27% | | (250 mol %), 65° C., 2 h | |
| MBAM | 3-APBA | AA | AMPSA | — | AlBN (0.4 mol %), DMSO | AP-153² |
| 19% | 27% | 27% | 27% | | (250 mol %), 65° C., 2 h | |
| MBAM | 3-APBA | AA | AMPSA | — | AlBN (0.8 mol %), DMSO | AP-154² |
| 19% | 27% | 27% | 27% | | (250 mol %), 65° C., 2 h | |
| MBAM | 3-APBA | AA | AMPSA | — | AlBN (1 mol %), DMSO | AP-155² |
| 19% | 27% | 27% | 27% | | (250 mol %), 65° C., 2 h | |

¹Also contains 1% guanosine;
²also contains 2% guanosine;
³also contains 3% guanosine;
⁴also contains 5% guanosine;
⁵also contains 10% NVP;
⁶also contains 12.5% AMPSA, 12.5% BMEP and 12.5% NVP.

### Example 4-Synthetic Complex Test Solutions

The preparation of solutions used for evaluation of binding and selectivity for guanosine capture materials, e.g., beer (5% ethanol in water, pH adjusted to 4 by acetic acid) is detailed below.

### Preparation of Stock Solution 10 ppm Guanosine in Neutral Water:

Guanosine (10 mg) was added to 999.99 g of water in a 1 L glass bottle with a screw cap. The solution was stirred overnight at room temperature and the resulting solution was 10 ppm guanosine in water.

### Preparation of Stock Solution 50 ppm Guanosine in Methanol:

Guanosine (50 mg) was added to 792 g of methanol in a 1 L glass bottle with a screw cap. The solution was stirred overnight at room temperature and the resulting solution was 50 ppm guanosine in methanol.

### Preparation of Stock Solution 50 ppm Guanosine in Simulated Beer Solution (SBS):

Guanosine (50 mg), acetic acid (50 microliters), ethanol (50 mL) were added to water (950 g). The solution was stirred overnight at room temperature and the resulting solution was 50 ppm guanosine in simulated beer solution (SBS) with a pH of approximately 4.

### Preparation of Stock Solution 50 ppm Guanosine, 50 ppm Ethyl Acetate, and 50 ppm Isoamyl Acetate in Simulated Beer Solution (SBS):

Guanosine (50 mg), ethyl acetate (50 mg), isoamyl acetate (50 mg), acetic acid (50 microliters), and ethanol (50 mL) were added to water (950 g). The solution was stirred overnight at room temperature and the resulting solution was 50 ppm guanosine, 50 ppm ethyl acetate, and 50 ppm isoamyl acetate in simulated beer with a pH of approximately 4.

### Preparation of Stock Solution 50 ppm Guanosine, 50 ppm Ethyl Acetate, and 50 ppm Isoamyl Acetate in Methanol:

Guanosine (50 mg), ethyl acetate (50 mg), isoamyl acetate (50 mg), were added to methanol (1000 mL). The solution was stirred overnight at room temperature and the resulting solution was 50 ppm guanosine, 50 ppm ethyl acetate, and 50 ppm isoamyl acetate in methanol.

### Preparation of Stock Solution 50 ppm Iso-Alpha Acids in Methanol:

Iso-alpha acids (50 mg), were added to methanol (1000 mL). The solution was stirred overnight at room temperature and the resulting solution was 50 ppm iso-alpha acids in methanol.

### Preparation of Stock Solution 50 ppm Iso-Alpha Acids in Simulated Beer:

Iso-alpha acids (50 mg), acetic acid (50 microliters), ethanol (50 mL) were added to water (950 g). The solution was stirred overnight at room temperature and the resulting solution was 50 ppm iso-alpha acids in simulated beer with a pH of approximately 4.

### Preparation of Stock Solution of 4-Purine Simulated Beer:

Xanthine (10 mg), hypoxanthine (10 mg), adenosine (10 mg), guanosine (10 mg), acetic acid (50 microliters), and ethanol (50 mL) were added to water (950 g). The solution was stirred overnight at room temperature and the resulting solution was 10 ppm solution of 4 purines in simulated beer with a pH of approximately 4.

### Example 5—Purine Removal from Complex Mixtures

Removal from Methanol Solution (Stirring Method; Analytical Quantification of Selectivity Using Gas Chromatography and UV Vis):

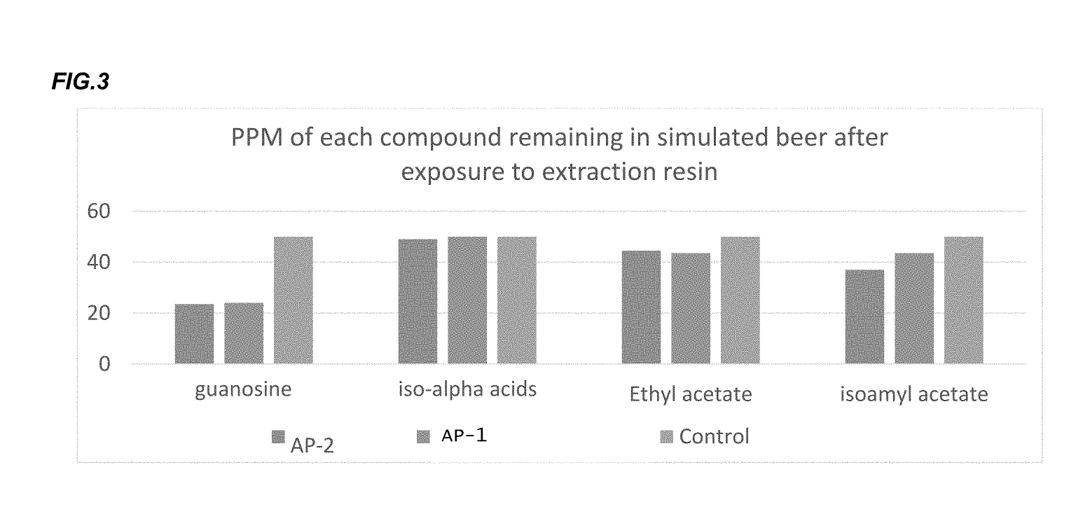

A testing solution was prepared as described above. To this solution was added 50 mg of affinity polymer in 5 mL of solution. The resulting mixture was stirred for 3.5 to 24 hours. After the 3.5 to 24-hour time period had passed, the solutions were passed through 0.2 micron polytetrafluoroethylene (PTFE) filters before injection onto the GC column. A series of three runs were performed on each of the test solutions as well as the control solutions. Peak elution times were observed to be 2.85 minutes for ethyl acetate and 6.30 minutes for isoamyl acetate. Peak areas of the esters were averaged between the three runs and the concentration of esters in the test solutions were compared to those obtained from the control samples in order to quantitatively determine the percentage of ester removal resulting from contact with the affinity polymer. The results are shown in FIG. 3

Ester selectivity tests were carried out using a Perkin Elmer Clarus 680 Gas Chromatograph (GC) equipped with a Restek RTX-5 Amine column (30 m length, 0.32 mm ID, 1.00 micron df), using helium as the carrier gas with a flow rate of 2.00 mL/min. An FID was used on the column with a temperature of 300° C. Gas flows through the detector were 450 ml/min of air and 45 ml/min of hydrogen. Samples of artificial beer solution were injected in 1 microliter volumes with the injection temperature set at 250° C. to volatilize the ester species. Sample run times were 10 minutes with the initial oven temperature being set at 50° C., then ramped at a rate of 10° C. per minute to a final temperature of 150° C. The sampling rate was set at 12.5 pts/s.

Evaluation of Guanosine Binding in Neutral Water, Methanol, and Simulated Beer (Stirring Method):

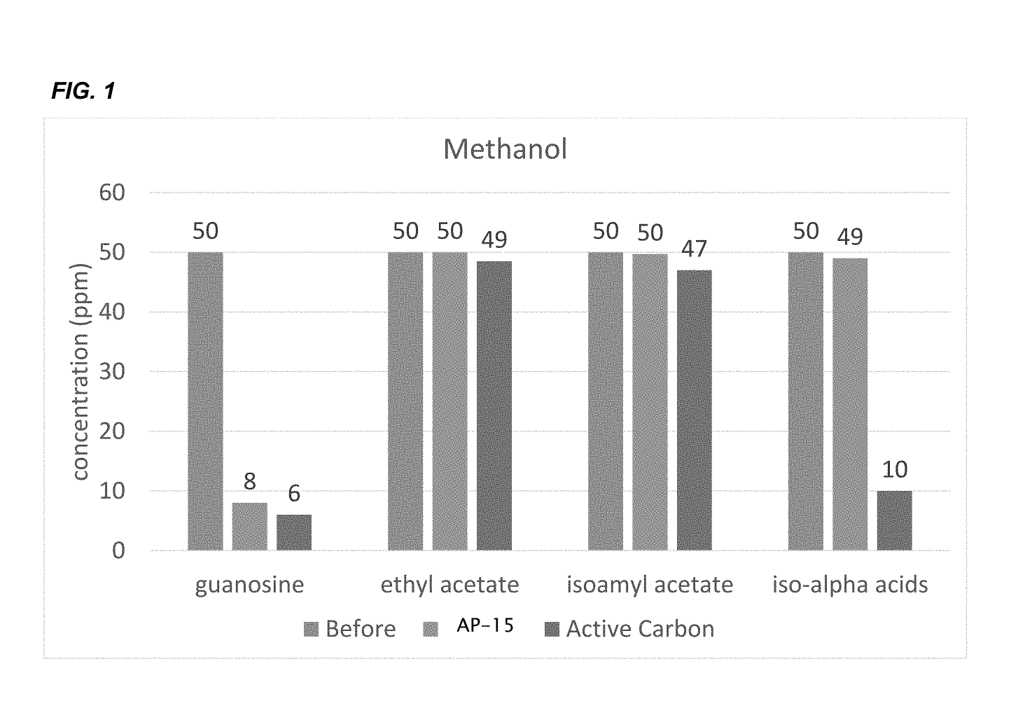

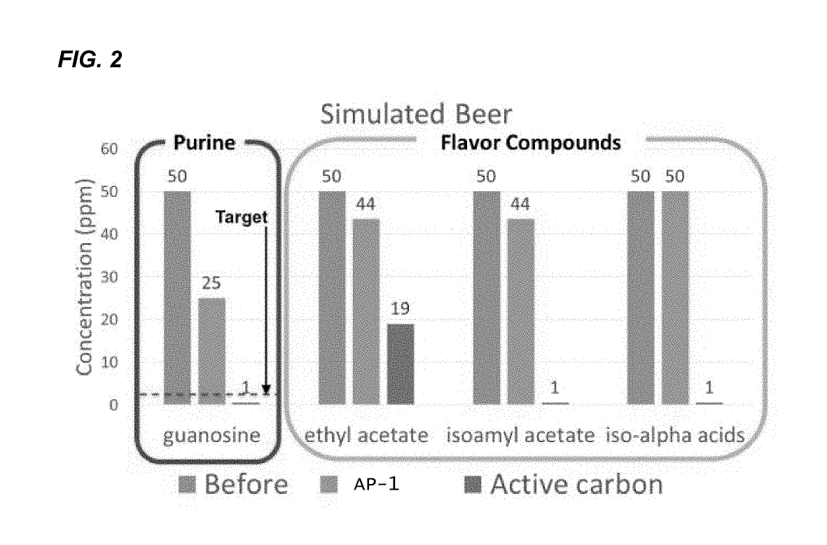

To a first 8 ml vial was added 5 ml of a stock solution of guanosine. To a second 8 ml vial was added 5 ml of the same stock solution and 50 mg of the affinity polymer material to be evaluated. The contents of the two vials were stirred for 3-24 hours. The contents of the first vial containing stock solution only were filtered through a 0.2 micron PTFE syringe filter, and the filtered liquid was transferred into a first spectrophotometric quartz cuvette having a 10 mm path length. The contents of the second vial containing the stock solution and the sorbent affinity polymer material of interest were filtered through a 0.2 micron PTFE syringe filter, and then the filtered liquid was transferred into a second spectrophotometric quartz cuvette having a 10 mm path length. The first quartz cuvette containing the standard liquid was then placed into the sample holder of a Shimadzu UV3600 UV-VIS-IR Spectrophotometer. The optical absorbance spectrum of the standard was measured from 400-200 nm using a medium scan speed and a slit width of 5 nm. The cuvette was removed and the second cuvette was placed in the sample holder of the instrument, and the absorbance spectrum was measured in the same manner. The absorbance intensity of the solution at each measured wavelength was plotted, and the value of the absorbance intensity at the peak absorbance wavelength (252 nm) was compared between the filtered standard solution and the filtered stock solution that had been in contact with the experimental affinity polymer material. The percentage difference between the two absorbance intensities was taken as the percentage of guanosine that was removed from the solution by the experimental material. The results for removal of guanosine, etc. from a methanol solution by AP-15 are shown in FIG. 1. The results for removal of guanosine, etc. from simulated beer solutions are shown in FIGS. 2 and 3.

Solid Phase Extraction Procedure for Simulated Beer Solutions (SBS):

### (A) Column Extraction Method of Standard Methanol Solution.

100 mg of monomeric AP-1 made as described above was packed in a fritted solid phase extraction cartridge. Before analysis, the polymer was conditioned with pure methanol, followed by 50% of methanol in water and solvent, then the sample (50 mg/L guanosine, 1 g/L maltose, 50 gm/L ethyl acetate, 5 mg/L isoamyl acetate, 50 mg/L of iso-alpha acids [percolated volume 25 ml, flow rate 1 ml/10 sec]) was percolated through the column. A washing solvent was performed after loading (water with 5% ethanol and 50 mg of acetic acid, pH=4.0 (solvent percolated volume 25 ml, flow rate 1 ml/10 sec). The results are shown in Table 3 below.

TABLE 3
Eluted and retained purine and flavor compounds.

| | | Loaded amount | |
|---|---|---|---|
| Complex mixture | Loaded amount | washed from | Total |
| component | eluted | cartridge | amount |
| guanosine | 57.9% | 40.2% | 98.1% |
| ethyl acetate | 93.0% | — | 93.0% |
| isoamyl acetate | 96.1% | — | 96.1% |
| maltose | 94.5% | — | 94.5% |

### (B) Column Extraction Method of Simulated Beer Solution (SBS).

100 mg of desired affinity polymer composite was weighed into a small vial. A primer solution, e.g., simulated beer solution (SBS), was added to 100 mg polymer to form a polymer slurry. The resultant polymer slurry was added to a SPE cartridge. The original vial was rinsed with about 1-3 mL additional SBS to make sure all of the polymer is transferred into the cartridge. The polymer in the cartridge was covered with a frit and packed mechanically. The cartridge was flushed with about 6 mL of SBS. The test solution was added in 3 mL fractions and collected individually for UV-Vis analysis. For guanosine binding assay, the test solution was 10 ppm guanosine in SBS, and 20 ppm ethyl acetate, and 2 ppm isoamyl acetate. For alpha acid binding assay, the test solution was 20 ppm iso-alpha acid standard in SBS. The test solution was passed through the cartridge until the assay endpoint. For guanosine binding assay, the endpoint was defined as the first fraction in which more than 1 ppm of guanosine was perceived as coming out of the cartridge. For alpha acids, the endpoint was defined as the first fraction in which more than 18 ppm of alpha acids were perceived as coming out of the cartridge. For each affinity polymer composite evaluated, a binding capacity of guanosine at 10% breakthrough and a binding capacity of alpha acids at 90% breakthrough was calculated. Then, the ratio of these two numbers was defined as the selectivity factor. For example, if a given affinity polymer composite absorbed a total of 1 mg of guanosine at the point where 1 ppm or more of guanosine is coming out of the cartridge, and it only absorbed 0.1 mg of alpha acids at the point where 18 ppm of alpha acids are coming out of the cartridge, then that polymer gets a selectivity factor of (1 mg guanosine)/(0.1 mg alpha acids)=10. The results are shown in Table 4, below.

TABLE 4
Simulated beer solution (SBS) with 10 ppm guanosine, 20 ppm iso-alpha acids.

| | mg of | mg of | mg of alpha | | Guanosine | alpha acid |
|---|---|---|---|---|---|---|
| | Affinity | guanosine | acid | | capacity at | capacity at |
| Affinity | Polymer | absorbed | absorbed at | | 10% | 90% |
| Polymer | composite | until 10% | 90% | Selectivity | breakthrough | breakthrough |
| composite | used | breakthrough | breakthrough | factor | (mg/g) | (mg/g) |
| MD- | 100 | 0.0297 | 0.0054 | 5 | 0.297 | 0.054 |
| BMEP6 | | | | | | |
| AP-94 | 100 | 0.2031 | 0.0066 | 31 | 2.031 | 0.066 |
| AP-97 | 100 | 0.144 | 0.0072 | 20 | 1.44 | 0.072 |
| AP-95 | 100 | 0.1449 | 0.0072 | 20 | 1.449 | 0.072 |
| AP-11 | 100 | 0.2949 | 0.1968 | 1.5 | 2.949 | 1.968 |
| AP-9 | 50 | 0.0786 | 0.0042 | 19 | 1.572 | 0.084 |
| AP-96 | 100 | na | 0.0006 | na | na | 0.006 |
| Boronate | 100 | 0.0084 | 0.006 | 1.4 | 0.084 | 0.06 |
| resin A¹ | | | | | | |
| AP-3 | 100 | 0.0717 | >0.1 | <1 | 0.717 | >1 |
| AP-4 | 100 | 0.1776 | 0.4338 | 0.4 | 1.776 | 4.338 |
| AP-100 | 100 | 0.2922 | 0.0066 | 44 | 2.922 | 0.066 |
| AP-101 | 100 | 0.0282 | 0.0018 | 16 | 0.282 | 0.018 |
| AP-103 | 100 | 0.1173 | 0.0054 | 22 | 1.173 | 0.054 |
| AP-102 | 100 | 0.0096 | 0.0174 | 0.6 | 0.096 | 0.174 |
| AP-98 | 100 | 0.0858 | 0.0048 | 18 | 0.858 | 0.048 |

¹G Biosciences Boronate resin, catalog number 786-314.

Based on the data in Table 4, it is observed that cross-linker DHEBAM has the lowest alpha acid binding of the cross-linkers tested.

### (C) Solid Phase Extraction Procedure for 4-Purine Simulated Beer Solutions (SBS):

100 mg of the affinity polymer composite to be tested for purine absorption is wetted with the simulated beer solution (SBS) until it is the consistency of a slurry.

The affinity polymer composite/SBS slurry is added to a solid phase extraction cartridge. Approximately 5-10 cartridge volumes of SBS is flowed through the cartridge to pack and equilibrate the polymer resin. Optionally, a frit can be added to the cartridge to mechanically hold the resin in place. The volume of SBS used can between about 3 mL and about 12 mL.

The 4-purine simulated beer test solution (prepared as described above) is flowed through the cartridge at a flow rate of approximately 0.5-2 mL/minute and the effluent is collected as fractions. The fraction size can be chosen to obtain whatever resolution is desired. In a typical experiment, a 1 mL fraction size is chosen, and the flow rate may not always be strictly controlled—the flow of conditioning solvents and testing solutions may be forced by hand using a 3 mL syringe in most cases.

The first 1 mL fraction and the tenth 1 mL fraction are analyzed by LC-MS, and the amount of each purine in the fraction is quantified based on the integration of the ion count from the mass spectrometer. The results of the experiments are shown below in Table 5.

TABLE 5
Simulated beer solution (SBS) - Removal of 4-
purine analogs by affinity polymer composites.

| Affinity | First or | % removed as measured by LC-MS | | | |
|---|---|---|---|---|---|
| Polymer | tenth 1 mL | Hypo- | | Adeno- | Guano- |
| composite | fraction | xanthine | Xanthine | sine | sine |
| AP-104 | First | 100 | 100 | 100 | 100 |
| | Tenth | 97 | 2 | 100 | 100 |
| AP-105 | First | 100 | 84 | 100 | 100 |
| | Tenth | 7 | 0 | 100 | 73 |
| AP-106 | First | 100 | 69 | 100 | 100 |
| | Tenth | 8 | 1 | 100 | 77 |
| AP-109 | First | 100 | 79 | 100 | 100 |
| | Tenth | 31 | 1 | 100 | 82 |
| AP-111 | First | 100 | 100 | 100 | 100 |
| | Tenth | 97 | 4 | 100 | 100 |
| AP-112 | First | 100 | 100 | 100 | 100 |
| | Tenth | 100 | 1 | 100 | 100 |
| AP-113 | First | 100 | 100 | 100 | 100 |
| | Tenth | 100 | 1 | 100 | 100 |
| AP-100 | First | 100 | 97 | 100 | 100 |
| | Tenth | 91 | 0 | 100 | 100 |
| AP101-1 | First | 100 | 84 | 100 | 100 |
| | Tenth | 37 | 3 | 100 | 60 |
| AP-114 | First | 100 | 47 | 100 | 100 |
| | Tenth | 18 | 2 | 100 | 46 |
| AP-116 | First | 100 | 100 | 100 | 100 |
| | Tenth | 84 | 0 | 100 | 100 |
| AP-117 | First | 100 | 100 | 100 | 100 |
| | Tenth | 96 | 2 | 100 | 100 |
| AP-118 | First | 52 | 12 | 96 | 24 |
| | Tenth | 19 | 2 | 80 | 8 |
| AP-119 | First | 5 | 3 | 14 | 3 |
| | Tenth | 1 | 1 | 2 | 0 |

Solid Phase Extraction Procedure for Real Beer Solutions (RBS):

A typical Japanese beer was purchased from a local retailer. The beer was poured into a glass contained and degassed by bubbling inert gas into the liquid through a needle. The degassed beer is stored in a refrigerator with the container sealed with a cap to minimize oxygen exposure. The beer solution is typically purged with inert gas every time a sample is taken. It is generally understood that alpha acids are sensitive to light and oxygen. For a typical small-scale experiment, a 20 mL glass scintillation vial is used. The affinity polymer composite of interest is weighed and added to the dry vial. Typical loading is 10 mg/mL, or 100 mg of dry resin in 10 mL of beer. In some embodiments, it is desirable to experiment with different loading amounts, such as 20 mg/mL, 6.7 mg/mL, or 5 mg/mL. Some embodiments require larger scale experiments (such as for taste testing) requiring a larger container but the procedure is the same. The stock container of degassed cold beer (approximately 40° F.) is taken out of the refrigerator, and 10 mL of beer (or any desired volume) is removed via a syringe. For larger scale tests, a graduated cylinder can be used.

The cold beer is added to the dry resin in the vial. For small scale, such as 10 mL in 100 mg of resin, the beer can be added all at once. For larger scale experiments, slow addition of the beer is desirable to avoid possible foaming due to incomplete degassing. A control beer sample is prepared in an identical vial, with the same volume, in the same refrigerator at the same time, with no affinity polymer composite material present. This control sample serves as the untreated calibration to compare the treated sample to in the LC-MS analysis. The vial with beer and affinity polymer composite is placed in the refrigerator for the desired time interval, such as 24 hours, 48 hours, or 72 hours. This time period of treating the sample with the affinity polymer composite is termed a “cold soak.” No stirring or agitation is needed for the small scale tests. For larger scale experiments, however, it may be beneficial to use some agitation, or to use a completely different method such as a packed column method. Typically, experiments did not require any agitation. At the desired time period, the control beer vial and affinity polymer composite-treated beer vial are removed from the refrigerator. A polypropylene syringe is used to take out a 1-1.5 mL sample of the beer, and then a 0.2 micron PTFE syringe filter is attached to the syringe, and the beer is filtered through the syringe filter directly into an LC-MS autosampler vial. The samples are immediately analyzed on an LC-MS instrument. Each purine and iso-alpha acid of interest is quantified separately based on the integration of the ion count from the mass spectrometer. The control sample is run 3 times, typically twice before and once after the affinity polymer composite sample. The data acquired using this method is shown below in Table 6.

TABLE 6
Real beer solution (RBS) - Removal of purines and flavor compounds following 24 h
refrigeration with affinity polymer composite.

| | mg | | | | | | | | | |
|---|---|---|---|---|---|---|---|---|---|---|
| Affinity | AP/ | % removed as measured by LC/MS | | | | | | | | |
| Polymer | mL | Hypo- | | | | | Phenyl- | | | |
| composite | RBS | xanthine | Xanthine | Adenosine | Guanosine | Tyrosine | alanine | Maltose | Isocohumulone | Isohumulone |
| AP-47 | 20 | 56 | 24 | 74 | 62 | 65 | 81 | −29 | 5 | 9 |
| AP-48 | 20 | 70 | 40 | 78 | 67 | 73 | 87 | 4 | 2 | 5 |
| AP-44 | 20 | 48 | 26 | 64 | 56 | 42 | 59 | −25 | 5 | 9 |
| AP-59 | 20 | 81 | 49 | 87 | 75 | 82 | 92 | −6 | 12 | 18 |
| AP-64 | 20 | 81 | 48 | 86 | 71 | 82 | 92 | −3 | 10 | 18 |
| AP-61 | 20 | 77 | 42 | 86 | 72 | 75 | 90 | −6 | 12 | 20 |
| AP-62 | 20 | 69 | 29 | 83 | 66 | 71 | 89 | −10 | 18 | 31 |
| AP-63 | 20 | 81 | 48 | 87 | 75 | 81 | 92 | −9 | 21 | 37 |
| AP-78 | 20 | 74 | 45 | 76 | 66 | 73 | 84 | 10 | 22 | 36 |
| AP-50 | 20 | 72 | 34 | 79 | 66 | 80 | 91 | 9 | 13 | 25 |
| AP-57 | 20 | 67 | 31 | 78 | 66 | 68 | 83 | −3 | 7 | 16 |
| AP-54 | 20 | 72 | 38 | 78 | 66 | 69 | 84 | 0 | 0 | 2 |
| AP-67 | 20 | 72 | 34 | 82 | 67 | 75 | 89 | −5 | 3 | 9 |
| AP-68 | 20 | 63 | 26 | 77 | 61 | 70 | 86 | −2 | 7 | 22 |
| AP-69 | 20 | 68 | 32 | 81 | 66 | 74 | 87 | 1 | 5 | 15 |
| AP-70 | 20 | 71 | 33 | 81 | 67 | 72 | 87 | −4 | 10 | 19 |
| AP-71 | 20 | 70 | 32 | 81 | 65 | 73 | 86 | −1 | 6 | 15 |
| AP-73 | 20 | 78 | 43 | 87 | 71 | 85 | 93 | 21 | 8 | 16 |
| AP-74 | 20 | 77 | 43 | 83 | 85 | 85 | 96 | 7 | 10 | 14 |
| AP-75 | 20 | 77 | 40 | 84 | 86 | 86 | 95 | 15 | 11 | 16 |
| AP-81 | 20 | 67 | 32 | 77 | 65 | 66 | 84 | −5 | 6 | 13 |
| AP-83 | 20 | 73 | 46 | 84 | 68 | 72 | 87 | 27 | 14 | 27 |
| AP-84 | 20 | 72 | 46 | 85 | 69 | 73 | 91 | 30 | 1 | 12 |
| AP-89 | 20 | 84 | 59 | 84 | 76 | 80 | 91 | 36 | 18 | 24 |
| AP-121 | 20 | 44 | 19 | 73 | 48 | 57 | 50 | 1 | 7 | 7 |
| | 20^{a} | 28 | 13 | 64 | 33 | 49 | 45 | 4 | 15 | 15 |
| | 10 | 10 | 7 | 50 | 19 | 24 | 19 | 1 | 1 | 3 |
| AP-120 | 20^{b} | 50 | 23 | 75 | 59 | 59 | 45^{c} | 1 | 6 | 5 |
| | 10^{b} | 18 | 10 | 56 | 46 | 30 | 17^{c} | −1 | 5 | 8 |
| | 6.7 | 14 | 6 | 41 | 26 | 22 | NT | 1 | 2 | 8 |
| | 5 | 4 | 3 | 31 | 16 | 11 | NT | −1 | 3 | 6 |
| AP-122 | 20 | 14 | 13 | 26 | 14 | 12 | 9 | 2 | 3 | 1 |
| AP-123 | 20 | 8 | 9 | 16 | 8 | 10 | 5 | 1 | 4 | 4 |
| AP-124 | 20 | 8 | 7 | 10 | 5 | 6 | 3 | −2 | 6 | 7 |
| AP-125 | 20 | 42 | 15 | 69 | 43 | 48 | 42 | 1 | 9 | 14 |
| AP-126 | 20 | 35 | 13 | 65 | 37 | 46 | 37 | 2 | 6 | 6 |
| AP-106 | 20 | 42 | 40 | 59 | 43 | 46 | 41 | 2 | 8 | 12 |
| AP-107 | 20 | 14 | 24 | 23 | 19 | 1 | 0 | −7 | 30 | 36 |
| AP-109 | 20 | 17 | 9 | 54 | 23 | 26 | 19 | −3 | 30 | 49 |
| AP-1B | 20 | 29 | 9 | 51 | 30 | 51 | 45 | 24 | 11 | 11 |
| AP-128 | 20^{b} | 55 | 23 | 70 | 60 | 52 | 44^{c} | −3 | 5 | 8 |
| | 10 | 27 | 9 | 42 | 34 | 28 | NT | −1 | 2 | 4 |
| | 6.7 | 10 | 3 | 33 | 22 | 12 | NT | −2 | 1 | 4 |
| | 5 | 4 | 2 | 22 | 10 | 2 | NT | −1 | 0 | 1 |
| AP-127 | 20^{b} | 59 | 25 | 73 | 65 | 63 | 54^{c} | −2 | 3 | 6 |
| | 10 | 21 | 7 | 46 | 36 | 28 | NT | −2 | 3 | 4 |
| | 6.7 | 11 | 6 | 25 | 17 | 12 | NT | 0 | −1 | 1 |
| | 5 | 4 | 1 | 20 | 10 | 4 | NT | −2 | −4 | −5 |
| AP-130 | 20 | 42 | 17 | 66 | 51 | 39 | NT | 1 | 2 | 5 |
| | 10 | 16 | 7 | 45 | 27 | 11 | NT | 0 | −1 | −2 |
| | 6.7 | 6 | 5 | 23 | 10 | 0 | NT | 0 | 0 | 1 |
| | 5 | 2 | 2 | 19 | 5 | −5 | NT | −1 | −1 | −2 |
| AP-133 | 20 | 48 | 19 | 66 | 61 | 51 | NT | −1 | 2 | 5 |
| | 10 | 16 | 7 | 32 | 22 | 14 | NT | −1 | 0 | 3 |
| | 6.7 | 6 | 2 | 25 | 12 | −1 | NT | −1 | 0 | −2 |
| | 5 | 1 | 1 | 13 | 3 | −6 | NT | −3 | 1 | |
| AP-134 | 20 | 59 | 32 | 72 | 67 | 54 | NT | 6 | 12 | 25 |
| | 10 | 30 | 16 | 51 | 38 | 26 | NT | 5 | 6 | 13 |
| AP-135 | 20 | 54 | 22 | 63 | 59 | 47 | NT | −1 | 11 | 29 |
| | 10 | 31 | 8 | 47 | 36 | 24 | NT | −3 | 2 | 6 |
| AP-136 | 20 | 59 | 33 | 72 | 61 | 56 | 76 | 8 | 5 | 13 |
| | 10 | 24 | 11 | 46 | 32 | 22 | 41 | 0 | −1 | 0 |
| AP-142 | 20 | 89 | 64 | 94 | 82 | 84 | 95 | −5 | 32 | 42 |
| | 10 | 51 | 27 | 77 | 61 | 44 | 78 | −4 | 23 | 28 |
| AP-143 | 20 | 84 | 58 | 89 | 76 | 77 | 92 | −6 | 29 | 35 |
| | 10 | 43 | 25 | 61 | 47 | 35 | 69 | −3 | 14 | 20 |
| AP-144 | 20 | 77 | 50 | 83 | 82 | 67 | 88 | −7 | 22 | 26 |
| | 10 | 33 | 23 | 50 | 34 | 22 | 59 | −3 | 13 | 17 |
| AP-145 | 20 | 82 | 56 | 89 | 78 | 72 | 89 | 2 | 24 | 30 |
| | 10^{b} | 42 | 26 | 65 | 55 | 33 | 66 | 1 | 13 | 20 |
| | 5 | 7 | 12 | 41 | 22 | 7 | 43 | 2 | 11 | 16 |
| AP-146 | 20 | 86 | 60 | 90 | 76 | 74 | 90 | −7 | 11 | 18 |
| | 10^{b} | 66 | 43 | 75 | 63 | 53 | 78 | 14 | 8 | 13 |
| | 5 | 13 | 11 | 52 | 29 | 7 | 52 | −2 | 6 | 10 |
| AP-147 | 20 | 78 | 48 | 81 | 83 | 65 | 83 | −2 | 12 | 21 |
| | 10 | 44 | 23 | 59 | 45 | 30 | 60 | −1 | 5 | 8 |
| AP-148 | 20 | 77 | 51 | 79 | 83 | 66 | 86 | −5 | 1 | 3 |
| | 10 | 39 | 21 | 59 | 52 | 29 | 58 | 0 | 2 | 6 |
| AP-149 | 20 | 53 | 36 | 63 | 60 | 41 | 67 | −2 | −3 | −1 |
| | 10 | 20 | 19 | 36 | 28 | 12 | 37 | −1 | 5 | 9 |
| AP-150 | 20 | 81 | 57 | 83 | 85 | 70 | 89 | −5 | 8 | 10 |
| | 10 | 48 | 27 | 56 | 47 | 34 | 65 | −2 | 10 | 15 |
| AP-151 | 20 | 70 | 43 | 74 | 80 | 61 | 81 | −3 | 5 | 10 |
| | 10 | 36 | 22 | 55 | 49 | 28 | 55 | 2 | 7 | 8 |
| AP-152 | 20 | 59 | 36 | 61 | 51 | 47 | 69 | −2 | 4 | 14 |
| | 10 | 29 | 20 | 50 | 35 | 20 | 46 | −1 | 2 | 5 |
| AP-153 | 20 | 50 | 32 | 54 | 46 | 38 | 62 | −1 | −1 | −3 |
| | 10 | 26 | 18 | 43 | 29 | 15 | 42 | 3 | 9 | 11 |
| AP-154 | 20 | 76 | 49 | 82 | 85 | 62 | 79 | 2 | 7 | 10 |
| | 10 | 41 | 21 | 62 | 48 | 25 | 49 | 1 | 4 | 5 |
| AP-155 | 20 | 76 | 47 | 80 | 83 | 64 | 81 | 0 | 3 | 5 |
| | 10 | 38 | 20 | 64 | 50 | 26 | 53 | 1 | 3 | 4 |

^{a}24 h at room temperature instead of refrigerated;
^{b}average of 2 experiments unless otherwise noted;
^{c}single experiment.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

The terms “a,” “an,” “the” and similar referents used in the context of describing the invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of any claim. No language in the specification should be construed as indicating any non-claimed element essential to the practice of the invention.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

### EMBODIMENTS

### Embodiment 1

An affinity composite comprising:
a cross-linking monomer component comprising at least one compound having an ethenyl group or polymerizable moiety and an acryl group moiety comprising an acrylol or amido acrylol group, the cross-linking monomer having first binding energy with a purine at least 1 kcal/mole different from second binding energy with flavor compound.

### Embodiment 2

The affinity composite of embodiment 1, further comprising an acidic monomer component comprising at least one compound having an ethenyl group or polymerizable moiety and an acidic group or acidic moiety comprising a sulfonic acid or a boronic acid group.

### Embodiment 3

The affinity composite of embodiment 1, wherein the ethenyl group is an acrylamido group.

### Embodiment 4

The affinity composite of embodiment 1, wherein the cross-linking monomer comprises a C₁-C₃-alkylacrylate group.

### Embodiment 5

The affinity composite of embodiment 1, wherein the cross-linking monomer is selected from at least ((hydroxyphosphoryl)bis(oxy))bis(ethane-2,1-diyl) bis(2-methylacrylate)(BMEP).

### Embodiment 6

The affinity composite of embodiment 1, wherein the cross-linking monomer is N,N′-(ethane-1,2-diyl)diacrylamide (BAE).

### Embodiment 7

The affinity composite of embodiment 2, wherein the acidic monomer component is selected from 2-acrylamido-2-methyl-1-propanesulfonic acid (AMPSA); 2-acrylamidophenylboronic acid (2APBA), or 3-acrylamidophenylboronic acid (3APBA).

### Embodiment 8

The affinity composite of embodiment 2, wherein the acidic monomer component is 4-vinylphenylboronic acid (4VPBA).

### Embodiment 9

The affinity composite of embodiment, wherein the acidic monomer is 6-((3-(4-amino-2-oxopyrimidin-1(2H)-yl)propanoyl)oxy)hexyl acrylate (C1POHA).

### Embodiment 10

A filtration media comprising the affinity composite materials of embodiments 1-9.

### Embodiment 11

The filtration media of embodiment 10, wherein the composite materials have a primary particle diameter of 40-100 micrometers.

### Embodiment 12

A filtration column comprising the affinity composite materials of embodiments 1-9.

### Embodiment 13

A method for removing purine from a complex mixture comprising:

Providing a complex aqueous mixture comprising a purine analogue compound and a flavor compound,

Contacting the filtration media of embodiments 1-9 to the complex aqueous mixture comprising a purine analogue, wherein the filtration media removes the purine analogue but not a flavor compound from the complex mixture.

1. An affinity polymer composite comprising a product of reacting a precursor mixture comprising at least one cross-linking monomer component having two or more ethenyl moieties suitable for polymerization; wherein the affinity polymer composite has a first binding energy with a purine compound that is at least 1 kcal/mole more favorable than a second binding energy with a flavor compound in a complex mixture.

2. The affinity polymer composite of claim 1, wherein the precursor mixture further comprises 1, 2, 3, 4, or 5 monomer components having one ethenyl moiety suitable for polymerization, wherein the monomer components comprise: 1) an ethylene or an acryloyl group; and 2) a CO₂H or a salt thereof; an SO₃H or a salt thereof; a —O—P(O)(OH)₂ or an ester or salt thereof; a —B(OH)₂ or an ester or salt thereof; a nitrogen containing group, or a combination thereof.

3. The affinity polymer composite of claim 2, wherein the cross-linking monomer component comprises: 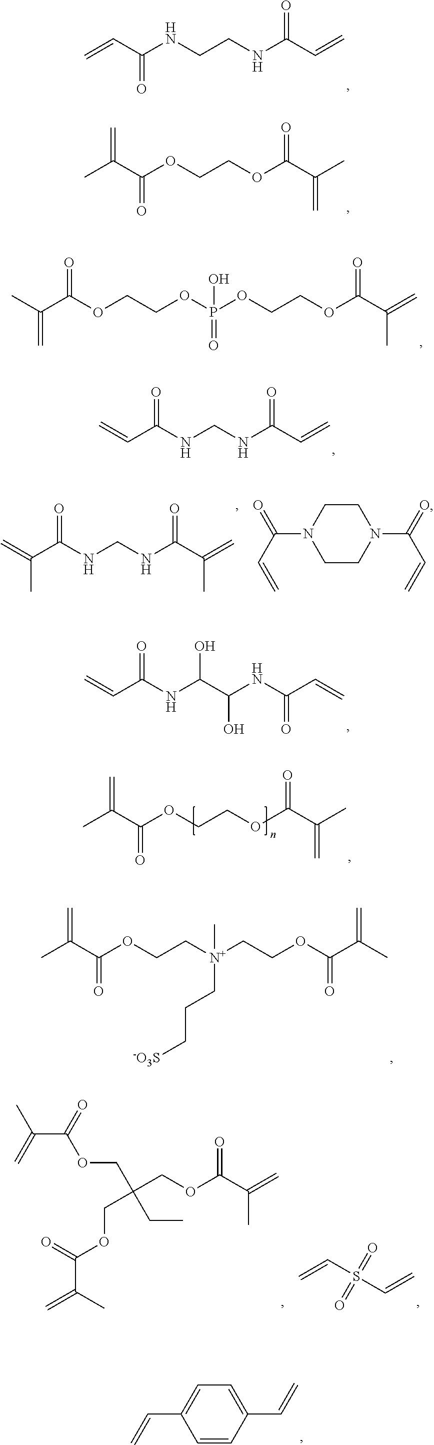
or any combination thereof.

4-20. (canceled)

21. The affinity polymer composite of claim 2, wherein the monomer components having one ethenyl moiety comprise: 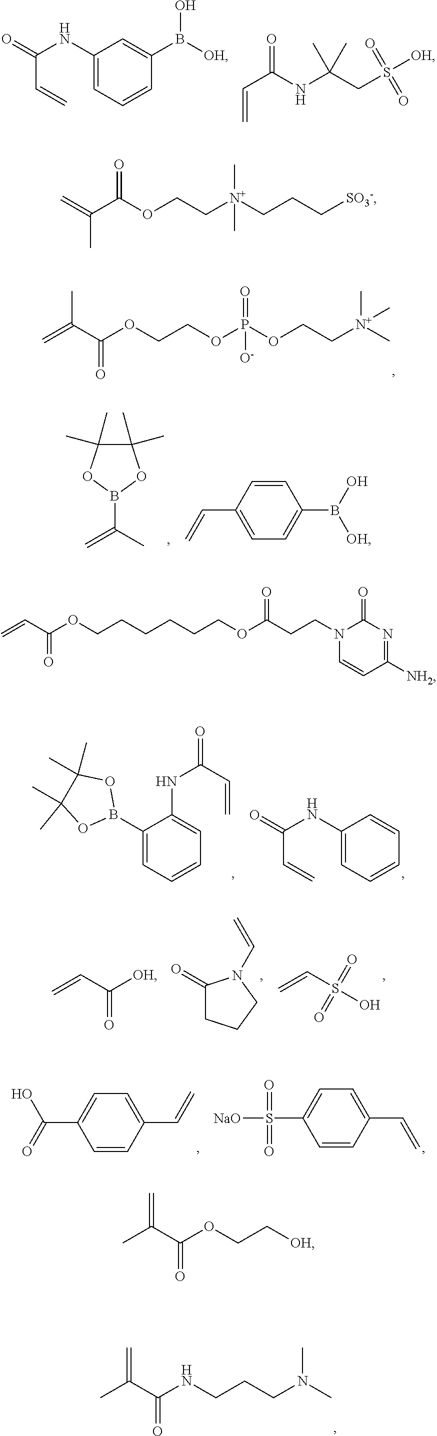 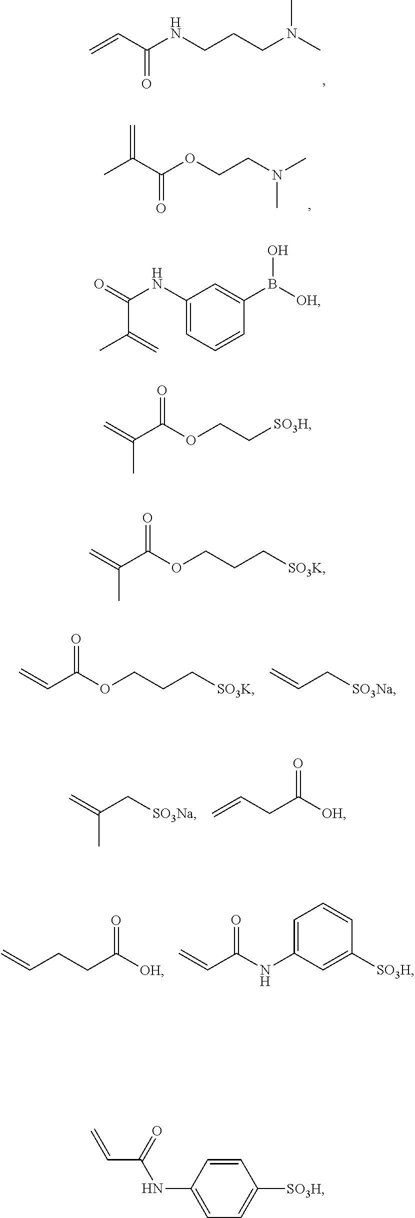
OH H or any combination thereof.

22. The affinity polymer composite of claim 2, wherein the cross-linking monomer component is bis[2-(methacryloxyloxy)ethyl] phosphate (BMEP):

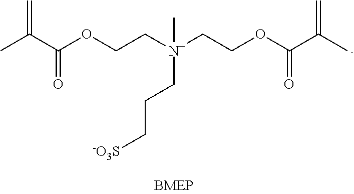

23. The affinity polymer composite of claim 2, wherein the cross-linking monomer component is 1,2-bis(acrylamide)ethane (EBAM):

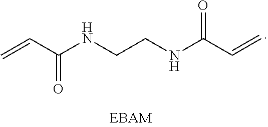

24. The affinity polymer composite of claim 2, wherein the cross-linking monomer component is methylene bisacrylamide (MBAM):

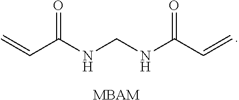

25. The affinity polymer composite of claim 2, wherein the cross-linking monomer component is TRIM:

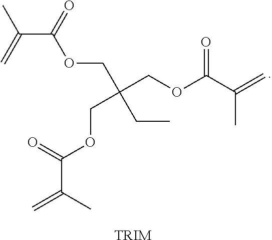

26. The affinity polymer composite of claim 2, wherein the monomer component having one ethenyl moiety is 6-((3-(4-amino-2-oxopyrimidin-1(2H)-yl)propanoyl)oxy)hexyl acrylate (C1POHA):

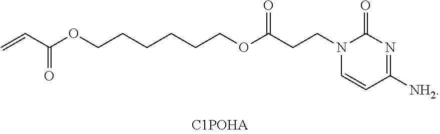 [SMILES: C=CC(=O)OCCCCCCOC(=O)CCn1ccc(N)nc1=O]

27. The affinity polymer composite of claim 2, wherein the monomer components having one ethenyl moiety comprise 3-acrylamidophenylboronic acid (3-APBA):

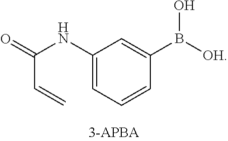

28. The affinity polymer composite of claim 2, wherein the monomer components having one ethenyl moiety comprise 2-acrylamido-2-methyl-propane-1-sulfonic acid (AMPSA):

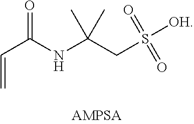

29. The affinity polymer composite of claim 2, wherein the monomer components having one ethenyl moiety comprise sodium 4-vinylphenylsulfonic acid (4-VPSAS):

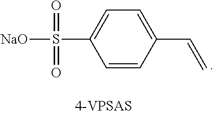

30. The affinity polymer composite of claim 2, wherein the monomer components having one ethenyl moiety comprise acrylic acid (AA):

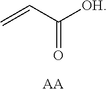

31. The affinity polymer composite of claim 2, wherein the monomer components having one ethenyl moiety comprise 4-vinylbenzoic acid (4-VBA):

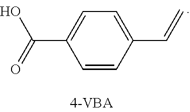

32. A filtration medium comprising the affinity polymer composite of claim 2, wherein the affinity polymer composite has a primary particle diameter of about 45 micrometers to about 150 micrometers.

33. A filtration column comprising the filtration medium of claim 32.

34. A method for the removal of a purine compound from a complex mixture comprising: treating a complex mixture with the filtration medium of claim 32, wherein the complex mixture comprises a purine compound and a flavor compound; wherein the filtration medium removes more of the purine compound from the complex mixture as compared to the amount of a flavor compound removed from the complex mixture.

35. The method of claim 34, wherein at least 70% of the purine compound is removed from the complex mixture, and at most 10% of the flavor compound is removed from the complex mixture.

36. The method of claim 34, wherein the complex mixture is beer or wort.

37. A heterogeneous mixture comprising a malt beverage and the affinity polymer composite of claim 2.
